(19) United States
(12) Patent Application Publication
(10) Pub. No.: US 2024/0188122 A1
(43) Pub. Date: Jun. 6, 2024

(54) SYSTEM AND METHOD TO DETERMINE INITIAL BANDWIDTH PART FOR A REDUCED CAPACITY DEVICE

(71) Applicant: Huawei Technologies Co., Ltd., Shenzhen (CN)

(72) Inventors: Vipul Desai, Palatine, IL (US); Brian Classon, St. Pete Beach, FL (US)

(21) Appl. No.: 18/427,650

(22) Filed: Jan. 30, 2024

Related U.S. Application Data
(63) Continuation of application No. PCT/US2022/039599, filed on Aug. 5, 2022.
(60) Provisional application No. 63/309,363, filed on Feb. 11, 2022.
(60) Provisional application No. 63/229,881, filed on Aug. 5, 2021.

(51) Int. Cl. H04W 74/00; H04W 72/0453; H04W 74/0833

(52) U.S. Cl. CPC H04W 74/006; H04W 72/0453; H04W 74/0833

(57) ABSTRACT

A reduced capability (RedCap) user equipment (UE) receives a system information block (SIB), in a first initial downlink (DL) bandwidth part (BWP) based on a first configuration within a master information block (MIB) received by the RedCap UE, the SIB indicating a second configuration for a second initial DL BWP, wherein the RedCap UE has a maximum bandwidth capability less than a minimum bandwidth capability for a non-RedCap UE, and wherein a bandwidth of the second initial DL BWP is no larger than the maximum bandwidth capability; receives transmissions in the first initial DL BWP before an initial access procedure; and receives transmissions in the second initial DL BWP during and after the initial access procedure in response to the RedCap UE transmitting a random access channel (RACH).

### CROSS-REFERENCE TO RELATED APPLICATIONS

This patent application is a continuation of International Patent Application No. PCT/US2022/039599, filed on Aug. 5, 2022 and entitled “System and Method to Determine Initial Bandwidth Part for a Reduced Capability Device,” which claims priority to U.S. Provisional Application No. 63/229,881, filed on Aug. 5, 2021 and entitled “System and Method to Determine Initial Bandwidth Part for a Reduced Capability Device,” and U.S. Provisional Application No. 63/309,363, filed on Feb. 11, 2022 and entitled “System and Method to Determine PUCCH Resources for RedCap UEs,” which applications are hereby incorporated by reference herein as if reproduced in their entireties.

### TECHNICAL FIELD

The present disclosure relates generally to managing the allocation of resources in a network, and in particular embodiments, to techniques and mechanisms for allocating resources to reduced capability devices.

### BACKGROUND

When a user equipment (UE) in the RRC_IDLE (RRC-idle) state attempts to find a base station, the UE first searches for synchronization signal blocks (SSBs) transmitted by a base station. After obtaining the SSB, it processes the physical broadcast channel (PBCH) to obtain the master information block (MIB) and parameters to establish the initial downlink (DL) bandwidth part (BWP) #0. These parameters include the search space #0 and control resource set (CORESET) #0 to obtain the physical downlink control channel (PDCCH). This initial DL BWP is used to receive the physical downlink shared channel (PDSCH) containing the system information block (SIB), which contains radio resource control (RRC) parameters. Among those RRC parameters are configurations for the initial uplink (UL) BWP, including random access, and possibly configuration for the initial DL BWP (which can override the MIB-based initial DL BWP “MIB-configured initial DL BWP”). The random access procedure can be triggered by initial access of a UE from the RRC-idle state.

### SUMMARY

Technical advantages are generally achieved, by embodiments of this disclosure which describe methods and techniques of initial access parameters and procedures, including the initial BWP, to support a device whose maximum supported bandwidth is less than the minimum support bandwidth of legacy devices.

In accordance with an embodiment, a method is provided. The method comprises, receiving, by a reduced capability (RedCap) user equipment (UE), a system information block (SIB), in a first initial downlink (DL) bandwidth part (BWP) based on a first configuration within a master information block (MIB) received by the RedCap UE, the SIB indicating a second configuration for a second initial DL BWP, wherein the RedCap UE has a maximum bandwidth capability less than a minimum bandwidth capability for a non-RedCap UE, and wherein a bandwidth of the second initial DL BWP is no larger than the maximum bandwidth capability; receiving, by the RedCap UE, transmissions in the first initial DL BWP before an initial access procedure; and receiving, by the RedCap UE, transmissions in the second initial DL BWP during and after the initial access procedure in response to the RedCap UE transmitting a random access channel (RACH).

Optionally, in any of the preceding aspects, the SIB comprises a configuration for an initial uplink (UL) BWP wherein a bandwidth of the initial UL BWP being smaller than or equal to the maximum bandwidth capability, the method further comprises, transmitting, by the RedCap UE, the RACH during the initial access procedure, in resources of the initial UL BWP.

Optionally, in any of the preceding aspects, a center of the initial UL BWP is aligned to a center of the second initial DL BWP, and wherein the RedCap UE operates with time-division duplexing.

Optionally, in any of the preceding aspects, the SIB comprises a configuration for an initial uplink (UL) BWP, a bandwidth of the initial UL BWP being less than or equal to the maximum bandwidth capability, the method further comprising, transmitting, by the RedCap UE, uplink control information in a physical uplink control channel (PUCCH) during the initial access procedure in resources of the initial UL BWP.

Optionally, in any of the preceding aspects, the transmitting of the uplink control information is in resources located on one side of the initial UL BWP in accordance with a configuration of PUCCH resources.

Optionally, in any of the preceding aspects, the configuration of PUCCH resources comprises an offset, a size of PUCCH resources, and an indication of a side of the initial UL BWP.

Optionally, in any of the preceding aspects, the first configuration comprises a first control channel resource set configuration and the second configuration comprises a second control channel resource set configuration.

In accordance with another embodiment, another method is provided. The method comprises, transmitting, by a base station, parameters for a first initial downlink (DL) bandwidth part (BWP) in a master information block (MIB), the MIB indicating a first configuration for the first initial DL BWP; transmitting, by the base station, a system information block (SIB), the SIB indicating a second configuration for a second initial DL BWP for a reduced capability (RedCap) UE, wherein the RedCap UE has a maximum bandwidth capability less than a minimum bandwidth capability for a non-RedCap UE, and wherein a bandwidth of the second initial DL BWP is no larger than the maximum bandwidth capability; and transmitting, by the base station, initial access messages in the second initial DL BWP in response to receiving a random access channel (RACH) from a RedCap UE.

Optionally, in any of the preceding aspects, the SIB further indicates a configuration for an initial uplink (UL) BWP, a bandwidth of the initial UL BWP being smaller than or equal to the maximum bandwidth capability.

Optionally, in any of the preceding aspects, a center of the initial UL BWP is aligned

to a center of the second initial DL BWP, and wherein the base station operates with time-division duplexing.

Optionally, in any of the preceding aspects, the method further comprises, configuring, by the base station, first parameters for a RACH transmission for the non-RedCap UE and second parameters for a RACH transmission for the RedCap UE.

Optionally, in any of the preceding aspects, the method further comprises, receiving, by the base station, uplink control information from the RedCap UE in a physical uplink control channel (PUCCH) during an initial access procedure in resources of the initial UL BWP.

Optionally, in any of the preceding aspects, the receiving of the uplink control information in the PUCCH is in resources located on one side of the initial UL BWP in accordance with a configuration of PUCCH resources.

Optionally, in any of the preceding aspects, the configuration of PUCCH resources comprises an offset, a size of PUCCH resources, and an indication of a side of the initial UL BWP.

Optionally, in any of the preceding aspects, the first configuration comprises a first control channel resource set configuration and the second configuration comprises a second control channel resource set configuration.

In accordance with yet another embodiment, a device for performing any of the preceding methods or aspects of the methods is provided. The device comprises, one or more processors; and a non-transitory memory storage comprising instructions that, when executed by the one or more processors, cause the device to perform a method of any of the preceding methods or aspects of the methods.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a diagram of an embodiment wireless communications network;

FIG. 2A illustrates a diagram of contention based random access (CBRA) with 4-step RA type;

FIG. 2B illustrates a diagram of CBRA with 2-step RA type;

FIG. 3A illustrates a diagram of SSB/CORESET #0 multiplexing patterns;

FIG. 3B illustrates a diagram of initial DL BWP signaled by a SIB;

FIG. 4A illustrates a diagram of initial DL BWP for a RedCap UE containing CORESET #0;

FIG. 4B illustrates a diagram of dynamically hopping initial DL BWP for a RedCap UE;

FIG. 4C illustrates a diagram of initial DL BWP for a RedCap excluding CORESET #0 derived from a MIB;

FIG. 4D illustrates a diagram of initial DL BWP for a RedCap including a CORESET #0 not derived from a MIB;

FIG. 5A illustrates a diagram of an example embodiment for CORESET #0 and SSB obtained from a MIB;

FIG. 5B illustrates a diagram of an example embodiment for CORESET #0 (CORESET #0R) used by a RedCap UE;

FIG. 5C illustrates a diagram of an example embodiment for different CORESET #0 for RedCap and non-RedCap UEs with the same search space #0;

FIG. 5D illustrates a diagram of an example embodiment for different CORESET #0 for RedCap and non-RedCap UEs with different search space #0;

FIG. 6 illustrates a diagram of channels for Msg. 1, Msg. 3, and response to Msg. 4;

FIG. 7A illustrates a diagram of an example embodiment of 4 RACH occasions (ROs) in an initial UL BWP for non-RedCap UEs;

FIG. 7B illustrates a diagram of an example embodiment of a RedCap RACH BWP that can support 4 ROs;

FIG. 7C illustrates a diagram of an example embodiment of a RedCap RACH BWP that can support the first two ROs from 4 ROs;

FIG. 7D illustrates a diagram of an example embodiment of separate ROs for RedCap UEs and non-RedCap UEs;

FIG. 7E illustrates a diagram of an example embodiment of time division multiplex (TDM) of RACH Occasions (RO) for non-RedCap UE and RedCap UE with two ROs;

FIG. 7F illustrates a diagram of an example embodiment of TDM of RO for non-RedCap UE and RedCap UE with two ROs;

FIG. 8A-FIG. 8B illustrate diagrams of example embodiments of UL BWP #0 PUSCH;

FIG. 9A-FIG. 9C illustrate diagrams of example embodiments of PUCCH hopping;

FIG. 10 illustrates a diagram of an embodiment for high level UE operation in accordance with example embodiments disclosed herein;

FIG. 11 illustrates a diagram of an embodiment for high level base station operation in accordance with example embodiments disclosed herein;

FIG. 12 illustrates a diagram of an embodiment for UL BWP used by UE in accordance with example embodiments disclosed herein;

FIG. 13 illustrates a diagram of an embodiment for PUSCH resource selection and PUCCH resource selection in accordance with example embodiments disclosed herein;

FIG. 14 illustrates a diagram of an example embodiment for SSB layout in a 5 MHz RF channel in accordance with example embodiments disclosed herein;

FIG. 15 illustrates a diagram of an embodiment for a general procedure to locate resource for PUCCH intraslot frequency hopping;

FIG. 16A illustrates a generic mapping for PUCCH with frequency hopping;

FIG. 16B illustrates locations of PUCCH resources when PUCCH is 2, 4, 10, and 14 symbols;

FIG. 17 illustrates a diagram of an embodiment for the selected resource blocks (RBs) for the first 7 indices assuming for N_{BWP}^{Size}=16 in accordance with example embodiments disclosed herein;

FIG. 18A illustrates a diagram of an embodiment of a BWP for non-RedCap UE with a region allocated for PUSCH;

FIG. 18B illustrates a diagram of an embodiment of a BWP for a RedCap UE;

FIG. 18C illustrates a diagram of an embodiment of overlaying BWPs for non-RedCap and RedCap UEs showing the problem of PUSCH fragmentation;

FIG. 18D illustrates a diagram of an embodiment of disabling frequency hopping for RedCap UEs;

FIG. 19A illustrates a diagram of an embodiment of using the lowest indexed RBs of BWP when frequency hopping is disabled;

FIG. 19B illustrates a diagram of an embodiment using the highest indexed RBs of BWP when frequency hopping is disabled;

FIG. 20A illustrates a diagram of an embodiment of N=ceiling(8/Ncs) with two N resources located consecutively in frequency;

FIG. 20B illustrates a diagram of an embodiment of N=ceiling(8/Ncs) with two N resources having the separation of offset between the lower edges of each resource;

FIG. 21A illustrates a diagram of an embodiment of PUCCH resources for RedCap and non-RedCap UEs overlapping and the lower edge of the BWP is aligned;

FIG. 21B illustrates a diagram of an embodiment of a use of offset2 to avoid overlap with frequency hopping disabled and the lower edge of the BWP aligned;

FIG. 21C illustrates a diagram of an embodiment of PUCCH resources for RedCap and non-RedCap UEs overlapping and the upper edge of the BWP is aligned;

FIG. 21D illustrates a diagram of an embodiment of a use of offset2 to avoid overlap with frequency hopping disabled and the upper edge of the BWP is aligned;

FIG. 21E illustrates a diagram of an embodiment of PUCCH resources for RedCap and non-RedCap UEs overlapping and the lower edge of the BWP is not aligned;

FIG. 21F illustrates a diagram of an embodiment of a use of offset2 to avoid overlap with frequency hopping disabled and the lower edge of the BWP is not aligned;

FIG. 21G illustrates a diagram of an embodiment of PUCCH resources for RedCap and non-RedCap UEs overlapping and the upper edge of the BWP is not aligned

FIG. 21H illustrates a diagram of an embodiment of a use of offset2 to avoid overlap with frequency hopping disabled and the upper edge of the BWP is not aligned;

FIG. 21I illustrates a diagram of an embodiment of PUCCH resources for RedCap and non-RedCap UEs overlapping and the edges of the BWP are aligned

FIG. 21J illustrates a diagram of an embodiment of a use of offset2 to avoid overlap with frequency hopping enabled and the edges of the BWP are aligned;

FIG. 21K illustrates a diagram of an embodiment of PUCCH resources for RedCap and non-RedCap UEs overlapping and the RedCap UE BWP is nested;

FIG. 21L illustrates a diagram of an embodiment of a use of offset2 to avoid overlap with frequency hopping enabled and the RedCap UE BWP is nested;

FIG. 22 illustrates a diagram of a MAC RAR message format in accordance with example embodiments disclosed herein;

FIG. 23 illustrates an example communication system according to example embodiments presented herein;

FIG. 24A and FIG. 24B illustrate example devices that may implement the methods and teachings according to this disclosure; and

FIG. 25 is a block diagram of a computing system that may be used for implementing the devices and methods disclosed herein.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Disclosed herein are methods and techniques of initial access parameters and procedures, including an initial BWP, to support a device whose maximum supported bandwidth is less than the minimum supported bandwidth of legacy devices. The methods and techniques serve to minimize resource utilization, signaling overhead, and enable coexistence between reduced capability (RedCap) and non-RedCap user equipments (UEs), e.g., legacy devices.

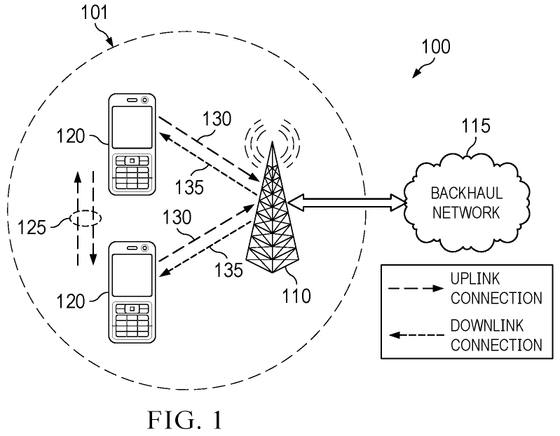

FIG. 1 illustrates an example communications system 100. Communications system 100 includes an access node 110 serving user equipments (UEs) with coverage 101, such as UEs 120. In a first operating mode, communications to and from a UE passes through access node 110 with a coverage area 101. The access node 110 is connected to a backhaul network 115 for connecting to the internet, operations and management, and so forth. In a second operating mode, communications to and from a UE do not pass through access node 110, however, access node 110 typically allocates resources used by the UE to communicate when specific conditions are met. Communications between a pair of UEs 120 can use a sidelink connection (shown as two separate one-way connections 125). In FIG. 1, the sideline communication is occurring between two UEs operating inside of coverage area 101. However, sidelink communications, in general, can occur when UEs 120 are both outside coverage area 101, both inside coverage area 101, or one inside and the other outside coverage area 101. Communication between a UE and access node pair occur over uni-directional communication links, where the communication links between the UE and the access node are referred to as uplinks 130, and the communication links between the access node and UE is referred to as downlinks 135.

Access nodes may also be commonly referred to as Node Bs, evolved Node Bs (eNBs), next generation (NG) Node Bs (gNBs), master eNBs (MeNBs), secondary eNBs (SeNBs), master gNBs (MgNBs), secondary gNBs (SgNBs), network controllers, control nodes, base stations, access points, transmission points (TPs), transmission-reception points (TRPs), cells, carriers, macro cells, femtocells, pico cells, and so on, while UEs may also be commonly referred to as mobile stations, mobiles, terminals, users, subscribers, stations, and the like. Access nodes may provide wireless access in accordance with one or more wireless communication protocols, e.g., the Third Generation Partnership Project (3GPP) long term evolution (LTE), LTE advanced (LTE-A), 5G, 5G LTE, 5G NR, sixth generation (6G), High Speed Packet Access (HSPA), the IEEE 802.11 family of standards, such as 802.11a/b/g/n/ac/ad/ax/ay/be, etc. While it is understood that communications systems may employ multiple access nodes capable of communicating with a number of UEs, only one access node and two UEs are illustrated for simplicity.

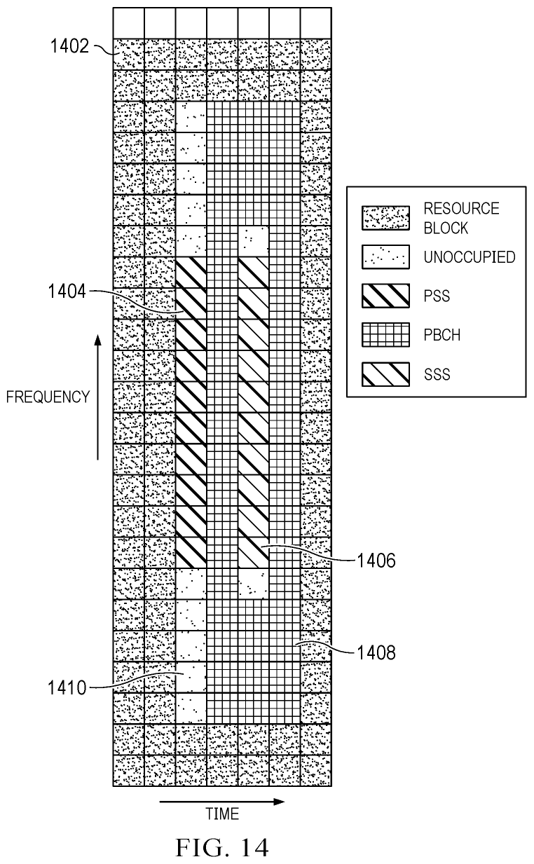

When a UE in the RRC_IDLE (RRC-idle) state attempts to find a base station, the UE first searches for SSBs transmitted by a base station. An example SSB is shown in FIG. 14. After obtaining the SSB, the UE processes the physical broadcast channel (PBCH) to obtain the MIB and parameters for the initial DL BWP (BWP #0). These parameters include the search space #0 and CORESET #0 to obtain the PDCCH. This initial DL BWP is used to receive the PDSCH containing the SIB, which contains RRC parameters. Among those RRC parameters are configurations for the initial UL BWP, including random access, and possibly configuration for the initial DL BWP (which can override the MIB-based initial DL BWP “MIB-derived initial DL BWP”). The random access procedure can be triggered by initial access of a UE from the RRC-idle state.

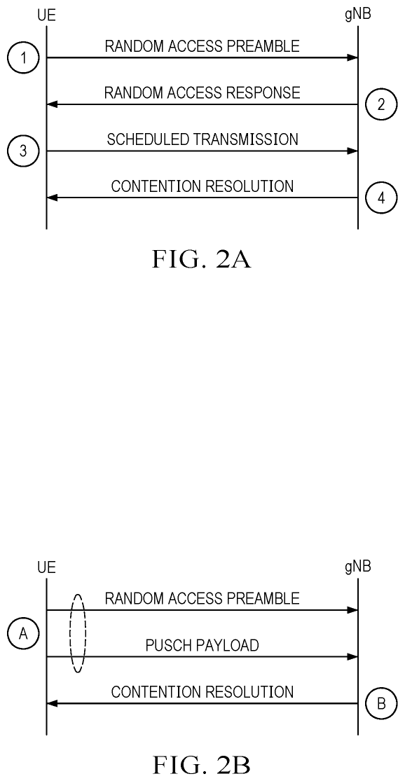

FIG. 2A and FIG. 2B show two types of contention based random access (CBRA). The numbered circles indicate the message number (i.e. 1→Msg1). For the discussions, the 4-step RACH process is described. The procedures are generally applicable to 2-step RACH.

The 3GPP Rel-17 includes specifying support for five UE complexity reduction features (reduced maximum bandwidth less than a required minimum bandwidth, reduced minimum number of Rx branches, reduced number of DL MIMO layers, relaxed maximum modulation order, and half duplex operation for FDD (frequency division duplex)).

With the reduced maximum bandwidth feature (e.g., for frequency range 1 (FR1) [˜600 MHz to ˜7 GHz], the supported bandwidth is reduced from a minimum bandwidth of 100 MHz to a maximum 20 MHz bandwidth; for frequency range 2 (FR2) [˜24 GHz to ˜70 GHz], the supported bandwidth is reduced from a minimum of 400 MHz to a maximum 100 MHz) can impact operation for initial access especially when resources for the messages (Msg1, Msg2, Msg3, Msg4, MsgA, MsgB) are based on the non-reduced (minimum) bandwidth.

In the standards, the configuration of the network assumes the resources for initial access are based on a UE (“non-RedCap UEs”) having a minimum requirement for the bandwidth and number of receive antennas/branches. The network formulates the initial BWP according to this minimum requirement. Note that the initial BWP formulation also considers the constraints due to the RF channel bandwidth. Here the term initial BWP can represent both the initial DL BWP and the initial UL BWP.

On the other hand, a reduced capability (RedCap) UE has a maximum requirement for the bandwidth and a number of receive branches that is less than the minimum requirements for a non-RedCap UE. Because the network has no knowledge of the presence of RedCap UEs during initial access, the initial BWP formulation for non-RedCap UEs may not work for RedCap UEs. However, a UE can expect to receive transmissions in the DL BWP and can expect to be scheduled to transmit in the UL BWP. This BWP cannot be larger than the RF channel bandwidth.

If the network configures the initial BWP in a manner appropriate for RedCap UEs, non-RedCap UEs can still perform initial access. However, there may be degradation in network performance as the initial BWP may be much smaller than desired for the non-RedCap UEs.

Alternatively, a second duplicate set of configurations signaling can be used to set up the initial BWP for the RedCap UEs. Both RedCap UEs and non-RedCap UEs can then access the network, at an increased cost in network signaling and network resources.

A solution for initial access that supports both types of UEs and minimizes network signaling/resources is desired. The solutions examine network configuration and UE behavior. They also consider how a network becomes aware of the presence of RedCap UEs, especially if the size of the UL BWP exceeds the maximum BW capability of a RedCap UE.

The following table lists how the initial BWP configurations for UL and DL are obtained for a UE. In addition, when the initial BWP configuration is provided in the SIB, there are two cases to consider based on the size of the BWP.

TABLE 1
Initial BWP configurations

| | No SIB signaling | |
|---|---|---|
| | (MIB-derived | |
| BWP | initial BWP) | SIB signaling |
| DL | BWP ≤ maximum | Case d1: BWP in DL SIB configuration |
| | RedCap BW; BWP | for non-RedCap UE ≤ maximum RedCap |
| | determined by | BW → initial DL BWP ≤ maximum |
| | CORESET#o | RedCap BW [if provided] |
| | | Case d2: BWP in DL SIB configuration |
| | | for non-RedCap UE > maximum RedCap |
| | | BW → how to ensure initial BWP used |
| | | by RedCap UEs ≤ maximum RedCap BW? |
| UL | Not applicable | Case u1: BWP in UL SIB configuration |
| | | for non-RedCap UE ≤ maximum RedCap |
| | | BW → initial UL BWP ≤ maximum |
| | | RedCap BW |
| | | Case u2: BWP in UL SIB configuration |
| | | for non-RedCap UE > maximum RedCap |
| | | BW → how to ensure initial BWP used |
| | | by RedCap UEs ≤ maximum RedCap BW? |

A high-level summary of the affected channels in various states is presented below.

TABLE 2
RedCap UE BWP limitations for various stages
of RRC-idle/RRC-connected. Also indicates
for the BWP configuration is obtained

| Stage | | DL | UL |
|---|---|---|---|
| (RRC-idle) | Obtained | SSB/CORESET#o | Not applicable |
| Acquisition of | Affected | | |
| MIB | channels | | |
| (RRC-idle) | Obtained | SIB configuration | SIB configuration |
| during initial | | (if provided) | |
| access | Affected | PDCCH (including | RACH/PUSCH/ |
| | channels | CORESET)/PDSCH | PUCCH |
| (RRC-idle) after | Obtained | | |
| completion of | Affected | PDCCH/PDSCH | PUSCH/PUCCH |
| Msg. 4 | channels | | |

A RedCap UE can always receive the SSB and PBCH since the bandwidth of the SSB is less than the maximum RedCap BW regardless of the SCS used (see FIG. 14). The configuration information for CORESET #0, obtained from the MIB, is used to establish the initial DL BWP (MIB-derived initial DL BWP). For all SCS configurations, the bandwidth of the MIB-derived initial DL BWP is less than or equal to the maximum RedCap BW.

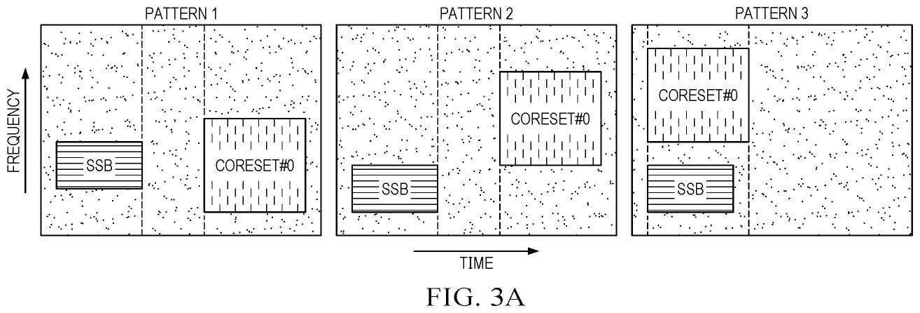

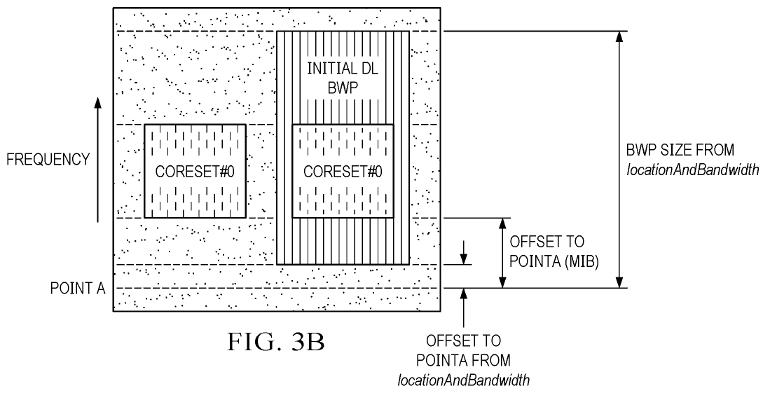

The standards also provide a time and frequency configuration between the SSB and CORESET #0, as shown by the three multiplexing patterns in FIG. 3A.
With pattern #1, the resources for the SSB and CORESET #0 overlap in frequency, but the transmissions of SSB and CORESET #0 occur in different time instances. The union of frequency resources is within the maximum RedCap UE bandwidth.
With pattern #2 (for FR2), the transmissions of SSB and CORESET #0 occur in different time instances, and the resources do not overlap in frequency. The bandwidth spanned by the resources for SSB and CORESET #0 is within the maximum RedCap UE bandwidth except for the case where the number of RBs for CORESET #0 is 48 and the absolute value of the offset between the SSB and CORESET #0 exceeds 40 RBs, for 240 kHz SCS for the SSB and 120 kHz SCS for CORESET #0.
With pattern #3 (for FR2), the transmissions of SSB and CORESET #0 occur in the same time instance, but the frequency resources do not overlap. The bandwidth spanned by the resources for SSB and CORESET #0 is slightly greater than the maximum RedCap UE bandwidth.

In the case with no SIB signaling, because the MIB-derived initial DL BWP≤maximum RedCap UE BW, no changes are necessary to the DL operation due to bandwidth.

In the case with SIB signaling with the initial DL BWP for non-RedCap UE≤maximum RedCap BW, when the network signals/transmits the configuration for the initial DL BWP in the SIB, the signaled BWP overrides the MIB-derived initial DL BWP. But if the signaled BWP≤maximum RedCap BW, the current operation behavior for receiving DL channels within CORESET #0 is unchanged. FIG. 3B shows how the RRC field locationAndBandwidth is used to establish the initial DL BWP from the SIB (offset from PointA and size).

For clarification, a DL BWP contains a CORESET, which defines the resources used to receive a DL control channel. A frequency span of any CORESET is less than or equal to the number of RBs in a DL BWP. A search space indicates when a particular CORESET is active (slot and symbol) for a UE and which radio network temporary identifier (RNTI) is active. The MIB provides parameters for an initial CORESET (CORESET #0) and an initial search space (search space #0). The configuration for both CORESET #0 and search space #0 can be overwritten by a SIB configuration.

In the case with SIB signaling with the initial DL BWP for non-RedCap UE>maximum RedCap BW, despite the larger initial DL BWP, the scheduling of PDSCH is within the resources spanned by CORESET #0 (for SI-RNTI (system information RNTI), RA-RNTI (random access RNTI), and TC-RNTI (temporary cell RNTI)). This initial DL BWP for non-RedCap UE may meet certain requirements, including that:
in case of time-division duplex (TDD), a BWP-pair (UL BWP and DL BWP with the same bwp-Id) must have the same center frequency,
the initial downlink BWP contains the entire CORESET #0 of this serving cell in the frequency domain.

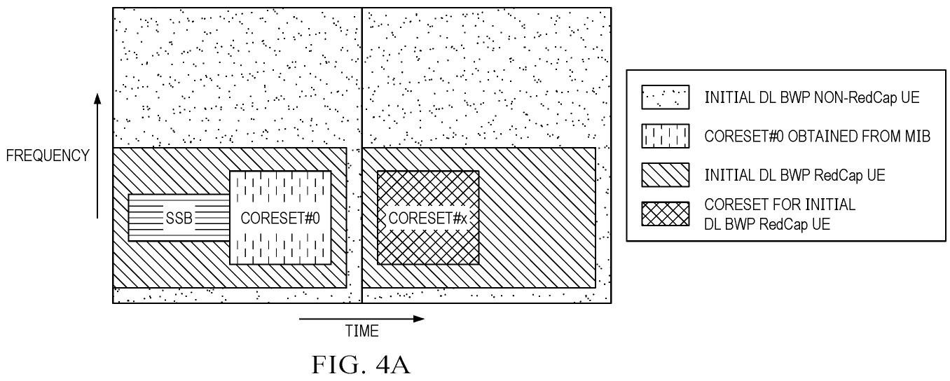

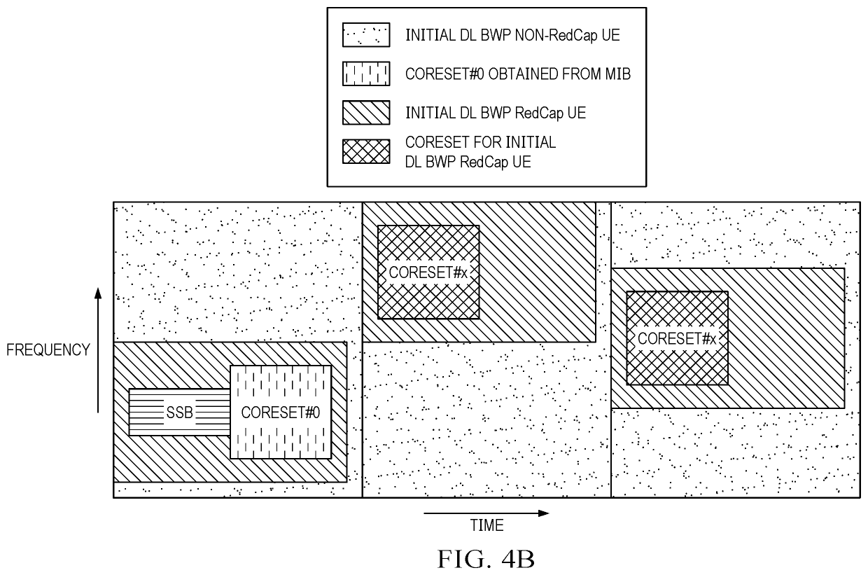

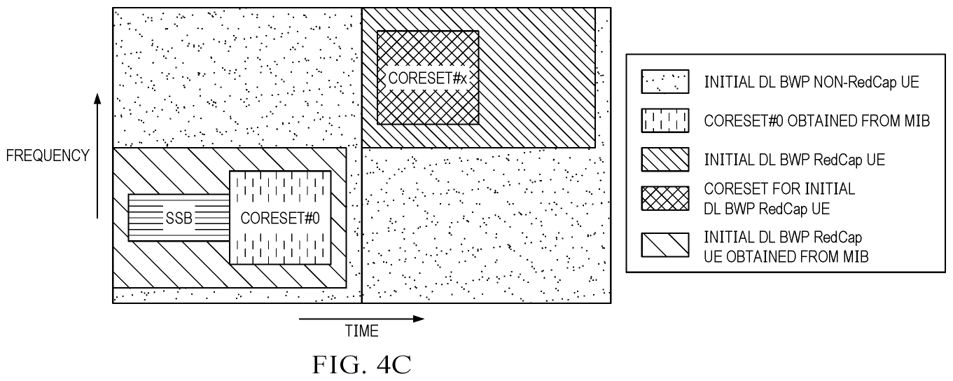

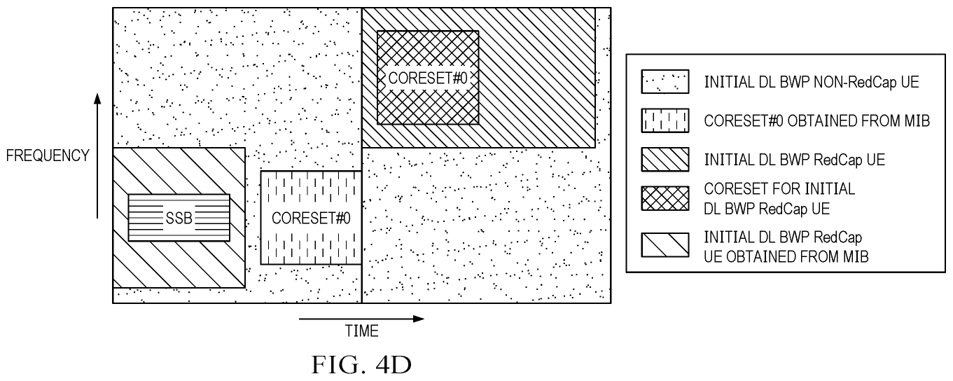

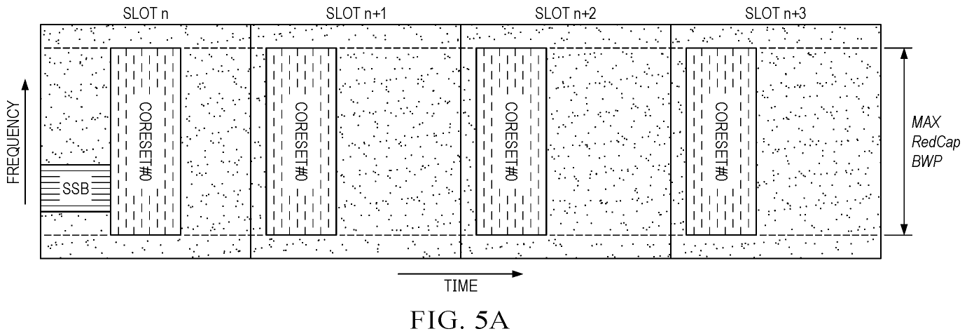

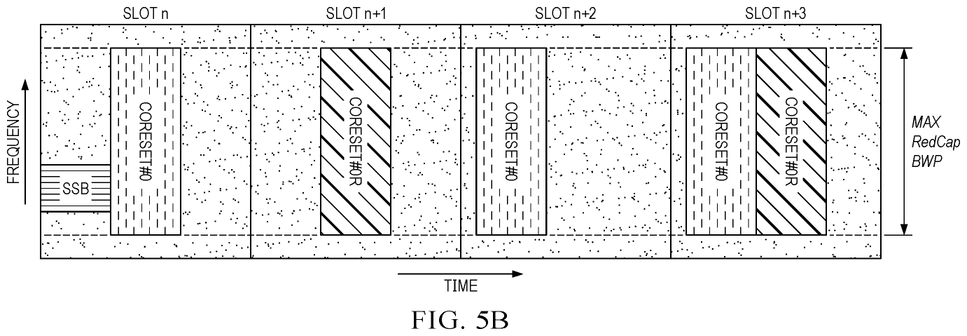

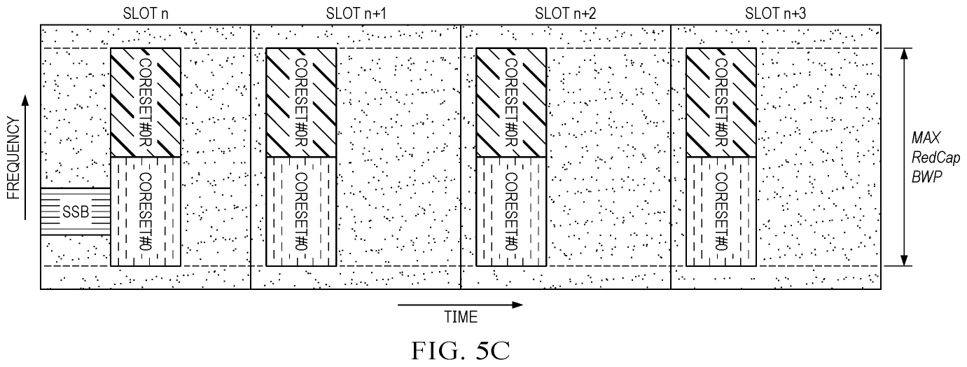

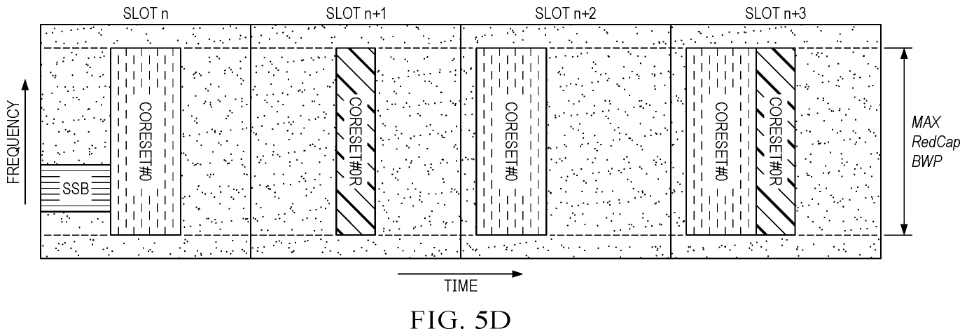

There are several approaches to provide an initial DL BWP for a RedCap UE (which has a bandwidth less than or equal to the maximum BW of a RedCap UE). FIG. 4A-FIG. 4D and FIG. 5A-FIG. 5D show several approaches.

In FIG. 4A, one possible approach is to restrict a RedCap UE to use the MIB-derived initial BWP. This may just a requirement in the standards. In a variation, it possible to provide an additional search space configuration for RedCap UEs so that only RedCap UEs monitor a CORESET (CORESET #x) within the MIB-derived initial BWP. Also note that because the PDSCH and scheduling PDCCH do not have to be in the same slot, it is possible to share the PDSCH (such as one containing a SIB message) between RedCap and non-RedCap UEs when the same scrambling seed is used. In another embodiment, if the network provides (via SIB) a CORESET #0 for non-RedCap UE, the RedCap UE uses that CORESET #0 and establishes its DL BWP based on the SIB-obtained CORESET #0. Note that a RedCap and a non-RedCap UE can share this MIB-derived DL BWP.

In FIG. 4B, a RedCap UE performs frequency hopping within a bandwidth indicated by the network. There may be a hopping pattern provided by the network. In some hops, CORESET #0 is available. In other slots there can be CORESET for RedCap UEs. This can be a form of implicit BWP switching where the same BWP is used but the frequency component is different. Note that most referencing inside a BWP is relative (except for the frequency location of a CORESET). There may be a timer involved for the hopping, where the time can be a number of slots/symbols. There is a time needed for frequency shift (perhaps on the order of 1-2 slots). For the CORESET, if the hop is a multiple of 6 RBs, the absolute addressing with the CORESET can be interpreted as a relative offset with the BWP. The hopping pattern may be related to a search space configuration.

In FIG. 4C, a RedCap UE operates in a different BWP (“initial DL BWP for a RedCap UE”) defined by a CORESET. When indicated (by a search space rule for example), a RedCap UE performs a BWP switch from the initial DL BWP to the MIB-derived initial DL BWP (or a SIB-obtained initial DL BWP). After a time duration (sufficient for reception of a PDSCH), the RedCap UE performs a BWP switch back to the initial DL BWP. There must be sufficient time to perform a BWP switch. The network cannot schedule PDSCH for RedCap UEs during the switch.

In FIG. 4D, a RedCap UE operation is similar to that in FIG. 4C except that the BWP switch is only for the SSB. The initial DL BWP for a RedCap UE has a CORESET #0. When indicated an occasion to monitor the SSB (measurement, reference signal tracking, etc.), a RedCap UE performs a BWP switch from the initial DL BWP to the MIB-derived initial DL BWP. After a time duration (several symbols) (sufficient for reception of a SSB), the RedCap UE performs a BWP switch back to the initial DL BWP. There must be sufficient time to perform a BWP switch. The network cannot schedule PDSCH for RedCap UEs during the switch.

A variation that does not involve switching for the base station to transmit an SSB in this initial DL BWP. In this case the base station informs the RedCap UE about the location of the SSB (Absolute Radio Frequency Channel Number (ARFCN), Global Synchronization Channel Number (GSCN)). Table 3 captures some of the possible standards impacts and behavior changes needed for the embodiments described by FIGS. 4A-4D.

TABLE 3
Example enabling elements for the embodiments described by FIGs. 4A-4D.

| | Base behavior/changes | RedCap UE behavior/changes |
|---|---|---|
| Restrict | None | Maintain initial DL BWP and |
| RedCap UE to | | disregard initial BWP |
| MIB-derived | | configuration sent in SIB |
| initial BWP | | |
| Restrict | None | Replace MIB-derived initial |
| RedCap UE to | | DL |
| SIB-obtained | | BWP by BWP corresponding to |
| CORESET#o | | SIB CORESET#o |
| Frequency | Establish a hopping pattern | Perform hopping, support |
| hopping | for the UE, transmit PDCCH/ | relative CORESETs |
| | PDSCH within the RedCap UE | |
| | BWP | |
| BWP switch | Establish a CORESET and DL | Timed BWP switch, which |
| | BWP for RedCap UEs. Schedule | CORESET to examine, new |
| | signaling based on search | search space rules. Can be |
| | space timing as an example | used for TDD alignment of |
| | New search space rules | UL/DL BWP. |
| BWP switch | Establish a CORESET#o | Support BWP switch in idle |
| for SSB | for RedCap UEs. Timing | state. Timing rules. Can be |
| | rules | used for TDD alignment of |
| | | UL/DL BWP. |

An alternate approach is to change the search space rules. In FIG. 5A-FIG. 5D, some possible search space #0 and CORESET #0 configurations from the baseline (FIG. 5A) are shown in FIG. 5B-FIG. 5D. For notation, let search space #0R denote the search space used by RedCap UEs. FIG. 5B shows a CORESET #0, designated as CORESET #0R, used by a RedCap UE. The same CORESET #0 configuration is used but different search space #0 for RedCap and non-RedCap UEs [i.e., search space #0R≠search space #0]. FIG. 5C shows a different CORESET #0 for RedCap and non-RedCap UEs but the same search space #0 [i.e., search space #0R=search space #0]. Note, a RedCap UE must know its CORESET #0R is based on search space #0. FIG. 5D shows different CORESET #0 and different search space #0 for RedCap and non-RedCap UEs. The timing in FIG. 5B can be derived from the timing in FIG. 5A.

If the time scheduling for search space #0 for non-RedCap UEs (which uses CORESET #0) is different than search space #0 for RedCap UEs, the same CORESET configuration can be used by a RedCap UE. The search space #0 configuration for RedCap UEs can be overwritten by a SIB configuration or be a defined offset from search space #0 for a non-RedCap UE. It is also possible to have separate search space configurations for each type of UE. It is possible to have a SIB-based search space #0 configuration for a non-RedCap UE while a RedCap UE uses the default search space #0 configuration.

It is noted that if a different search space #0 is used for RedCap UEs, there may be an increase in control channel overhead. But with the time domain resource assignment (TDRA), it is possible that the same PDSCH can be referred to by different control channels (in time and/or frequency). A RedCap UE can have a dedicated TDRA values (offset to the original value)

Since, for initial access of RedCap UEs, PDSCH and PDCCH are transmitted within the resources spanned by CORESET #0, a RedCap UE can effectively operate in the bandwidth of CORESET #0 (or CORESET #0R) which is less than or equal to the maximum BW of a RedCap UE.

From a UE perspective, it needs to know what the DL BWP is: it can be CORESET #0 or an initial DL BWP for RedCap UE, which contains CORESET #0. Note it is possible to define/configure an initial DL BWP for RedCap UE to be the same as the non-RedCap UE when the initial DL BWP for non-RedCap UE≤maximum RedCap BW.

A base station does not know the presence of RedCap UEs until possibly during the RACH process.

In one example embodiment for a UE, a RedCap UE receives a system information block (SIB), wherein the RedCap UE operates in a first initial downlink (DL) bandwidth part (BWP) based on a first configuration received from a master information block (MIB), the SIB indicating a second configuration for a second initial DL BWP, wherein the RedCap UE has a maximum bandwidth capability less than a minimum bandwidth capability for a non-RedCap UE, and wherein a bandwidth of the second initial DL BWP is no larger than the maximum bandwidth capability. The RedCap UE receives transmissions in the first initial DL BWP before an initial access procedure. The RedCap UE receives transmissions in the second initial DL BWP during and after the initial access procedure in response to the RedCap UE transmitting a random access channel (RACH).

In an example embodiment for a base station, a base station, capable of supporting a RedCap UE with a maximum BW less than a minimum BW for a non-RedCap UE, transmits a SIB with a configuration for a second initial DL BWP, wherein the configuration for the second initial DL BWP is used to determine an initial DL BWP for the RedCap UE, comprising parameters to replace a first initial DL BWP established from information from a received MIB.

In another example embodiment, a base station provides a first search space rule for a CORESET #0 according to an information in a MIB, wherein the first search space rule has a first timing, providing a second search rule for a RedCap UE with a maximum BW less than a minimum BW for a non-RedCap UE, wherein the second search space rule has a second timing.

It is noted that with a temporary DL BWP, the MIB derived CORESET can be used until initial access. If a RedCap UE receives an initial DL BWP configuration with a BW greater than the maximum BW of a RedCap UE, the RedCap UE can establish an initial DL BWP based on CORESET #0. This CORESET #0 can be the MIB-derived initial BWP. The starting location of the initial DL BWP can be the first RB of CORESET #0 and the number of RBs is the span of CORESET #0. The same search space #0 or different search space #0 can be used.

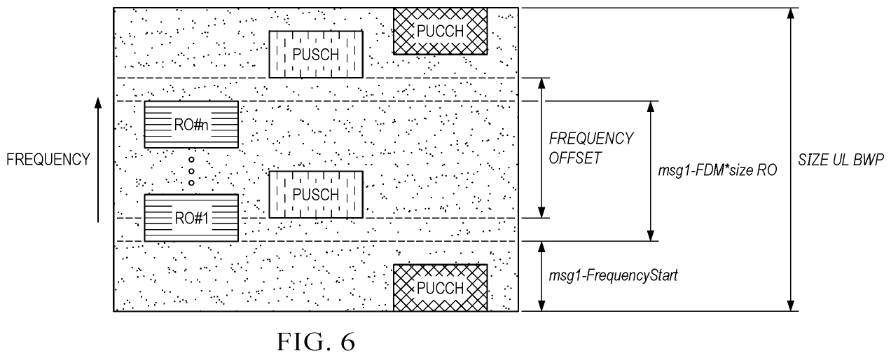

The UL BWP for initial access has several details to resolve especially when the initial UL BWP for non-RedCap UEs exceeds the maximum RedCap UE bandwidth. FIG. 6 shows the relative frequency locations of the uplink channels used during initial access. In general, the issues are:
For RACH, the RACH occasions (ROs) are frequency division multiplexed (FDM) with the number provided by the parameter msg1-FDM. Thus, the size of the FDM ROs is the product of the size of an individual RO and the parameter msg1-FDM. The size of an individual RO is a function of the SCS and the root sequence. While the maximum size of an individual RO is less than the maximum bandwidth of a RedCap UE, the overall bandwidth of the FDM ROs can exceed the maximum bandwidth of a RedCap UE.
For RACH, the starting location of first RO is determined by msg1-FrequencyStart.
For PUSCH, the channel for a UE is dynamically scheduled during initial access, and the starting location can be anywhere within the UL BWP.
For PUSCH, if frequency hopping is enabled, the frequency separation between PUSCH transmitted in the first half of a slot and second half of a slot can exceed the maximum bandwidth of a RedCap UE. The indication for hopping is in Msg2.
For PUCCH, the frequency separation of the resources, located on both edges of the UL BWP, can exceed the maximum bandwidth of a RedCap UE
In case of TDD, a BWP-pair (UL BWP and DL BWP with the same bwp-Id) must have the same center frequency.

The RACH occasion (RO) that a UE uses has a correspondence to the SSB identified by the UE. A RACH waveform is carried in a physical random access channel (PRACH). Multiple SSBs can map into the same RO. To support multiple SSB mappings, the RACH preambles can be divided into groups of P where P preambles (or cyclic shifts) correspond to one SSB. In contention-based RA, a UE randomly selects a preamble (preamble index, cyclic shift of a root sequence) from a set of allowed preambles (e.g. P) of the root sequence. The RACH waveform is based on several factors including the preamble, and the SCS. Note, the network is unaware of the presence of RedCap UEs.

Below are some problems to be solved:
When ROs are frequency division multiplexed (FDMed), the span can exceed the maximum RedCap UE bandwidth. How can the RedCap UE select the RO that is within the maximum bandwidth of RedCap UE? Equivalently, how can the network ensure the RO is within the BW of the RedCap UE?
What is the BWP for RO for a RedCap UE? (size, location)?
RACH occasions are mapped into a RA-RNTI used to identify the DCI that schedules the PDSCH carrying Msg2. Can the RO be used to distinguish a RedCap UE from a non-RedCap UE?
Can one set of preambles be used for RedCap UEs and a different set for non-RedCap UEs?
How to reuse resources between RedCap UEs and non-RedCap UEs?
Early indication (how a network can become aware of a RedCap UE)?

TABLE 4
Combinations of initial UL BWP size

| | Size of initial UL BWP | Size of initial UL BWP |
|---|---|---|
| | for non-RedCap UE ≤ | for non-RedCap UE > |
| | maximum BW of | maximum BW of |
| | RedCap UE | RedCap UE |
| Separate | | Allows network to schedule |
| PRACH | | PUSCH within maximum BW of |
| occasion | | RedCap UE |
| | | RACH occasions located within |
| | | maximum BW of RedCap UE |
| | | Separate RO may be able to |
| | | provide early indication |
| PRACH | | Allows network to schedule |
| preamble | | PUSCH within maximum BW of |
| partitioning | | RedCap UE |
| | | Is a form of early indication |
| | | Allows sharing of PRACH |
| | | occasions |
| | | Must ensure PRACH |
| | | occasions located within |
| | | maximum BW of RedCap UE |
| Separate | | May require a separate |
| initial UL | | CORESET or different search |
| BWP | | space#o if PRACH occasions |
| | | are aligned in time |
| | | A form of early indication |
| None | Can reuse non-RedCap | Unclear UE behavior |
| | UE configuration | |
| Notes | PUSCH and PUCCH are | |
| | located within maximum | |
| | BW of RedCap UE | |

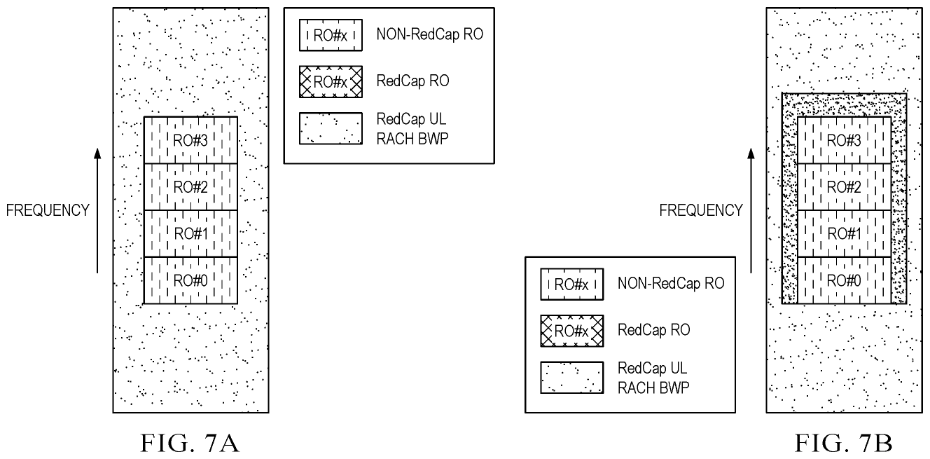

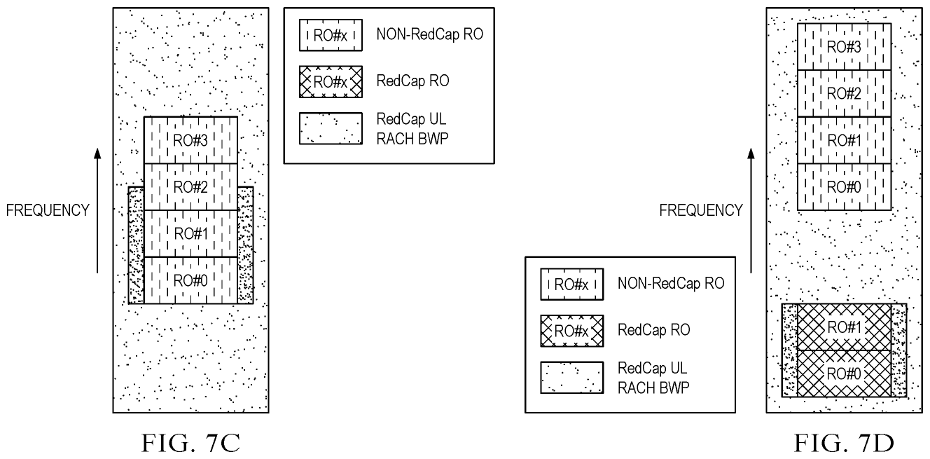

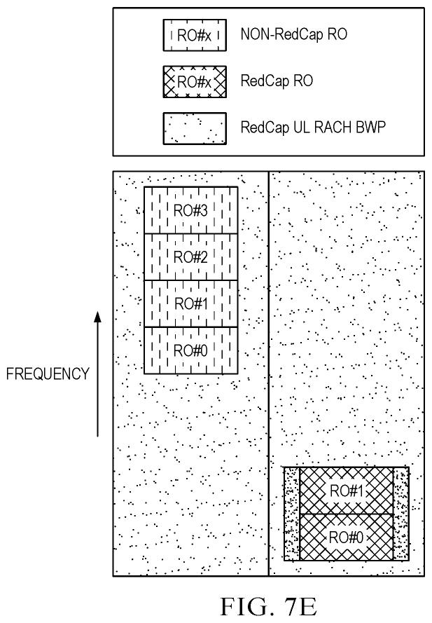

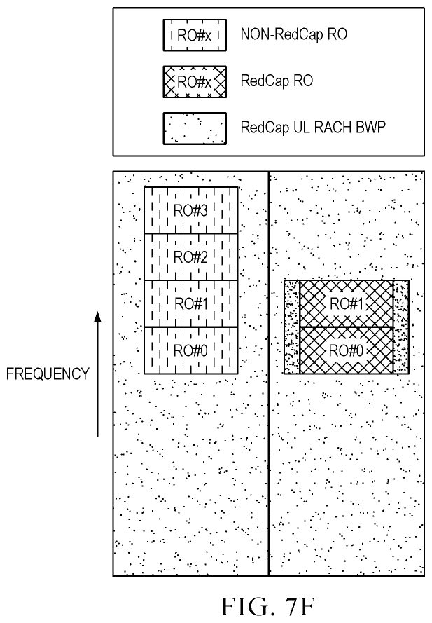

Some possible ROs layouts are shown in FIG. 7A-FIG. 7F. The scenarios for sharing RO are listed in Table 4 as a function the size of initial UL BWP for non-RedCap UE in relation to the maximum BW of RedCap UE. Table 5 shows a comparison of supporting the same or different root sequence for the RACH preamble and whether the same set of preamble indices used or separate sets of preamble indices. An example of the same root sequence is when a length 839 sequence is used and the index for both RedCap and non-RedCap UEs is 73. An example of the different root sequence is when a length 839 sequence is used and the index for the RedCap UE is 97 and non-RedCap UEs is 79. An example of same set of preamble indices is if both RedCap and non-RedCap UEs can use any index from [1 . . . 31]. An example of separate set of preamble indices is if both RedCap UE can use any index from [1 . . . 15] and a non-RedCap UE can use any index from [32 . . . 47]. Note if RedCap UE and non-RedCap UE can share at least one index, it can be considered a shared set.

In NR, the initial UL BWP supports RACH as well as PUCCH/PUSCH. In one embodiment as shown in FIG. 7A-FIG. 7F, the RACH is contained in its own BWP (UL RACH BWP) while the PUCCH/PUSCH can be in a different BWP (or the UL BWP for RedCap UEs). Note the UL RACH BWP can also be a placeholder for the UL BWP for RedCap UEs.

When resources are shared, early indication may be needed to ensure scheduled PUSCH and PUCCH are within the maximum BW of a RedCap UE and also within the initial UL BWP for a RedCap UE.

FIG. 7D shows an example of separate frequency resources for ROs for non-RedCap and RedCap UEs in the same slot. FIG. 7E shows an example of separate frequency resources for ROs for non-RedCap and RedCap UEs in different slots. FIG. 7F shows an example of some common frequency resources for ROs for non-RedCap and RedCap UEs in different slots. Some observations for the RO shown in FIG. 7D-FIG. 7F are captured in Table 5 (cases (d)-(f), respectively).

TABLE 5
Sharing of Resources for RO and PDCCH

| | | | Size of initial UL BWP for | Size of initial UL BWP for |
|---|---|---|---|---|
| | | Shared | non-RedCap UE ≤ | non-RedCap UE > |
| | Shared | PDCCH | maximum BW of RedCap | maximum BW of RedCap |
| | RO | Msg2 | UE | UE |
| (a) FDM RO | Y | Y | (ok) | Cannot be supported - |
| | | | | BWP too large |
| (b) FDM RO | Y | Y | (ok) | While ok, the issue is with |
| with RACH | | | | Msg3 and PUCCH for |
| BWP | | | | Msg4. Early indication |
| | | | | may be needed. |
| (c) FDM RO | Y | Y | criterion needed to select | criterion needed to select |
| for non- | | | RO (case where initial | RO, issue is with Msg3 |
| RedCap UE > | | | RedCap BWP < FDM | and PUCCH for Msg4 |
| RACH BWP | | | RO <= maximum BW | Early indication may be |
| | | | RedCap UE | needed. |
| (d) Separate | N | N | Separate CORESET#o or | Separate CORESET#o or |
| FDM RO in | | | separate search space#o | separate search space#o |
| frequency | | | or mutual exclusive sets | or mutual exclusive sets |
| | | | of preamble indices. This | of preamble indices. This |
| | | | a form of early indication | a form of early indication |
| (e) Separate | N | Y | Ok. This a form of early | Ok. This a form of early |
| FDM RO in | | | indication | indication |
| frequency | | | | |
| and time | | | | |
| (f) Separate | N | Y | Ok. This a form of early | Ok. This a form of early |
| FDM RO in | | | indication | indication |
| time | | | | |

TABLE 6
Identifying RedCap UEs via Msg1 (early indication)

| | Notes | Same Root | | Different Root | |
|---|---|---|---|---|---|
| | Set of Preambles for non- | sequence | | sequence | |
| | RedCap and RedCap UEs | Shared | Separate | Shared | Separate |
| (a) FDM RO | * If 2-step RACH not | N | Y | Y* | Y |
| | supported by network, can use | | | | |
| | RA-RNTI if standard can | | | | |
| | support | | | | |
| (b) FDM RO | * If 2-step RACH not | N | Y | Y* | Y |
| with RACH | supported by network, can use | | | | |
| BWP | RA-RNTI if standard can | | | | |
| | support | | | | |
| (c) FDM RO | * need Msg3 identification | Partial | Y | Partial* | Y |
| for non- | If Size of initial UL BWP for | * | | | |
| RedCap UE > | non-RedCap UE > maximum | | | | |
| RACH BWP | BW of RedCap UE, need to | | | | |
| | ensure PUCCH is within | | | | |
| | maximum bandwidth of | | | | |
| | RedCap UE | | | | |
| (d) Separate | | Y | Y | Y | Y |
| FDM RO in | | | | | |
| frequency | | | | | |
| (e) Separate | | Y | Y | Y | Y |
| FDM RO in | | | | | |
| frequency and | | | | | |
| time | | | | | |
| (f) Separate | | Y | Y | Y | Y |
| FDM RO in | | | | | |
| time | | | | | |

In FIG. 7C, with a mask (such as a mask for UE capable of supporting 2-step and 4-step RACH), a RedCap UE can be informed which shared FDM RO cannot be used (potentially removing ROs that are outside the maximum bandwidth of a RedCap UE). If only the first RO among {1,2,4,8} FDM RO can be used, a rule, such as

k mod msg1-FDM<1

where k indicates the kth available FDM RO, k=0, . . . , msg1-FDM−1; The mask would point to a value in the table whose value is 1. Likewise, for the first four ROs, the rule would be k mod msg1-FDM<4.

The UE can also determine which ROs can be supported by considering its own bandwidth and the bandwidth of the FDM ROs.

In FIG. 7B, while sharing can be shown possible, distinguishing RedCap UEs and non-RedCap UEs may be needed in order to ensure the transmission of Msg3 (PUSCH) is within the maximum bandwidth of a RedCap UE:
If the RedCap UE and non-RedCap UE can use the same set of preamble indices (of the same root sequence) in the same RO, then the resources for PUSCH (Msg3) should map into span of RBs usable by a RedCap UE for Msg3 and frequency hopping is disabled. In this scenario, the transmission of Msg3 would have to be modified so that a RedCap UE can be identified. This is necessary for the feedback of receiving Msg4. (This is applicable when the UL BWP>maximum BW RedCap UE)
If the RedCap UE and non-RedCap UE can use the same set of preamble indices (of different root sequences) in the same RO, using the approach of UEs sharing the RO for 2-step and 4-step RACH may be applicable under certain circumstances. If the network supports RedCap UEs and prohibits 2-step and 4-step RACH from sharing the same RO, then the RA-RNTI used by non-RedCap UEs can be different than the RA-RNTI for RedCap UE. The different RA-RNTIs allow the network to use different preambles in the same RO.

The issue with using different RA-RNTIs for is that the RNTI space is limited to a maximum value of 65535. The current limit for the RA-RNTI is 35840 when both 2-step and 4-step RACH are supported in the same RO. If 2-step and 4-step RACH cannot be supported in the same RO when a network supports RedCap UEs, then modifying the RA-RNTI calculation is possible.

From Table 5, when a RedCap UE and a non-RedCap UE have different (non-overlapping) sets of preamble indices, the RedCap UEs can share the same RO resources as non-RedCap UEs while still being identifiable in Msg2.

When the size of initial UL BWP for non-RedCap UE>maximum BW of RedCap UE, the initial UL BWP for RedCap UE (UL BWP #0RACH) can start at the location of the first FDM RO (e.g. given by msg1-FrequencyStart). The size of the BWP can be min(maximum BW of RedCap UE, size of FDM ROs, size of masked FDM ROs). This is a temporary BWP that is only active when a RedCap UE can perform a RACH. Note for TDD considerations, if this BWP-id is different than the CORESET #0 BWP, the center frequencies of the BWPs do not have to align.

In one example embodiment, a network transmits to a UE, a configuration for the RACH preamble and indicating resources for a RACH occasion in a UL BWP, receives a RACH on the resources of the RACH occasion, transmits a resource assignment for Msg3 in a PDCCH, wherein the resource assignment is in accordance with the RACH occasion on which the RACH was received and the RACH preamble. The RA-RNTI is computed with respect to the RO. Both the RO used as well as the preamble used can indicate whether a RedCap UE is accessing the system. The grant (address/interleaving) for the PUSCH is then based on this.

A RedCap UE receives a configuration for a first RACH preamble and indicating a first resources for a RACH occasion in a UL BWP, establishes an UL BWP for RedCap, further identifying second resources for the RO for RedCap in accordance with the UL BWP and the first resources for the RACH occasion, identifying a second RACH preamble, transmits a RACH in the UL BWP for RedCap UE on the second resources and using the second preamble, receives a PDCCH in accordance with the second resources and a random access response (RAR) containing the second preamble, and transmits a PUSCH in response to the RAR.

Without frequency hopping, the PUSCH transmission is one slot (e.g., 14 symbols). With frequency hopping enabled, the PUSCH transmission is divided into halves with the first half occupying the first 7 symbols of a slot and the second half occupying the last 7 symbols of a slot. The first half and second half of the PUSCH transmission are separated by a frequency offset. There are procedures how to set the magnitude of the frequency offset. Currently, the magnitude can be either └BW/4┘ or └BW/2┘. Note the offset is the number of RBs between the first RB of each half. If the number of RBs for PUSCH is N RBs, the span in frequency for transmission of PUSCH with hopping is N+└BW/4┘ or N+└BW/2┘.

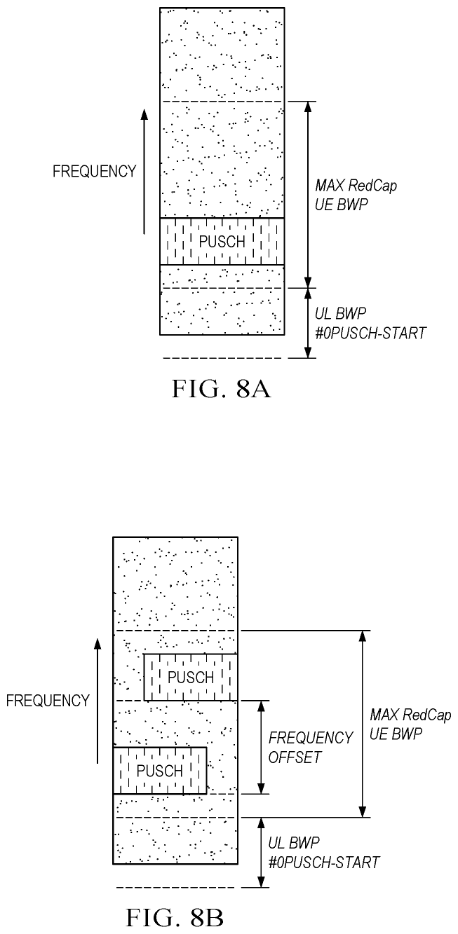

With RedCap UEs, the location of the initial UL BWP for RedCap UEs when transmitting PUSCH is unclear when the size of the initial UL BWP for non-RedCap UEs>maximum RedCap UE BW. In order to establish the initial UL BWP for RedCap UEs, the network can configure/define the starting RB of the BWP with respect to PointA (or to the RO). For brevity, let UL BWP #0PUSCH denote the initial UL BWP for RedCap UEs for used transmitting PUSCH as shown in FIG. 8A-FIG. 8B.
The size of UL BWP #0PUSCH can be equal to or less than the maximum RedCap UE BW and may have to be configured/defined.
The size of UL BWP #0PUSCH can be used in the formula for determining the frequency hop
Since the starting location of UL BWP #0PUSCH is known with respect to PointA, in the scheduling assignment for Msg2, the location within UL BWP #0PUSCH can be used. The size used in the RIV encoding (described below, assuming N=106) can be as large as 13 bits. N=106 is the number of RBs in 20 MHz for 15 kHz SCS. This is 1 bit less than the current 14-bit field in the scheduling grant. That 1-bit field can be reserved for future use. As a note, N=51 for 30 kHz SCS, 11 bits are needed. The unused bits can be reserved.
The center of the UL BWP can be the center of initial DL BWP for RedCap UE. The size can be the same or as large as the maximum BW of a RedCap UE.

Typically, a resource indicator value (RIV) encoding procedure is used to combine the starting location and size in RBs into one unit to save some signaling bits. By combining, the encoded size is ┌log₂ N(N+1)/2┐ bits, where N is the maximum number of RBs and the starting location can be anywhere among the N RBs. Assuming the value of N=275 RBs for the maximum bandwidth, the size is 16 bits. Sending ┌log₂ N┐ bits each for the size and start requires 18 bits. For example, the locationAndBandwidth field combines the starting location and size of the initial DL BWP using the RIV encoding procedure.

It is noted that since the bandwidth of RedCap UEs is limited to 20 MHz, the size of the combined field can be smaller than 16 bits. For example, consider 15 kHz SCS. The maximum bandwidth in RBs is 106 for a RedCap UE. Let M represent the maximum size of the non-RedCap UE bandwidth in RBs (typically M=275), let N represent the maximum size of RedCap UE bandwidth in RBs (N=106 for 15 kHz SCS and 20 MHz), let L be the actual RedCap UE bandwidth in RBs, L≤N, and S be the starting location of UL BWP #0PUSCH. One example of the RIV encoding is

$$RIV = \{ \begin{matrix}( M - N ) ( L - 1 ) + S , & 0 < S < M - N ; 1 \leq L \leq N \\ ( M - N ) N + N ( L - 1 ) + S - ( M - N ) & M - N \leq S < M ; ( L - 1 ) \leq ⌊ N / 2 ⌋ \\ ( M - N ) N + N ( N - L + 1 ) + ( N - 1 - ( S - ( M - N ) ) ) & M - N \leq S < M ; ( L - 1 ) > ⌊ N / 2 ⌋\end{matrix} \begin{matrix} \\ \\ \end{matrix}$$

With simplification,

$$RIV = \{ \begin{matrix}( M - N ) ( L - 1 ) + S , & 0 < S < M - N ; 1 \leq L \leq N \\ ( M - N ) ( N - 1 ) + N ( L - 1 ) + S & M - N \leq S < M ; ( L - 1 ) \leq ⌊ N / 2 ⌋ \\ ( M - N ) ( N + 1 ) + N ( N - L + 1 ) + ( N - 1 - S ) & M - N \leq S < M ; ( L - 1 ) > ⌊ N / 2 ⌋\end{matrix}$$

The first case in the calculation is where the BWP can be the maximum size of N. The latter two cases are where there is a constraint in the starting location, BWP size, and the maximum size of the non-RedCap UE bandwidth.

Alternatively, subchannels in units of MHz (or multiple RBs) can be used. For example, a 100 MHz bandwidth can be divided in twenty 5 MHz subchannels. The network can then signal the starting subchannel and number of subchannels.

Note that RedCap and non-RedCap UEs can share resource space for PUSCH within the UL BWP #0PUSCH It is noted that UL BWP #0PUSCH can be the same as UL BWP #0RACH, one can be a subset of the other BWP, or there is some overlap of RBs between BWPs.

The transmission of the PUCCH was identified as a problem when the initial UL BWP for non-RedCap UEs>maximum bandwidth of RedCap UEs. The reason is that some formats of the PUCCH are typically transmitted over two consecutive symbols, with one symbol located on one side of the UL BWP (e.g. lowest numbered RB in the UL BWP) while the next symbol is located on the other side (e.g. highest number RB in the UL BWP). This is a form of frequency hopping. When the frequency offset between the locations exceeds maximum bandwidth of a RedCap UE, a RedCap UE cannot switch frequencies in time (the time gap between symbols is too short).

Some approaches to address this issue are to:
Confine the PUCCH into its own BWP or reuse the RedCap UL BWP for the PUSCH
   It is noted that PUCCH transmissions may restrict PUSCH transmissions from other UEs in the same slot. As a result, the largest PUSCH for other UEs may be limited.
Remove the hopping requirement for RedCap UEs (especially during initial access). This is also applicable to confining the PUCCH locations within a RedCap UE bandwidth.
   Problems identified are removing hopping minimizes any performance benefit from frequency diversity.

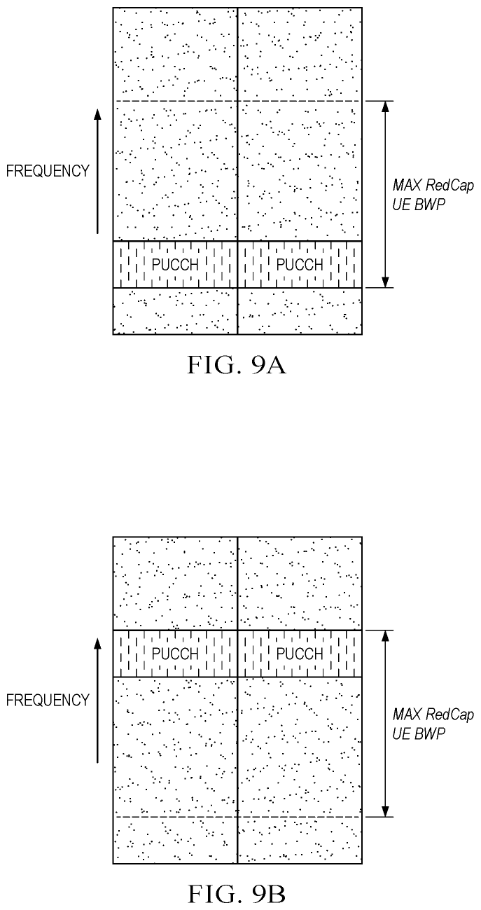

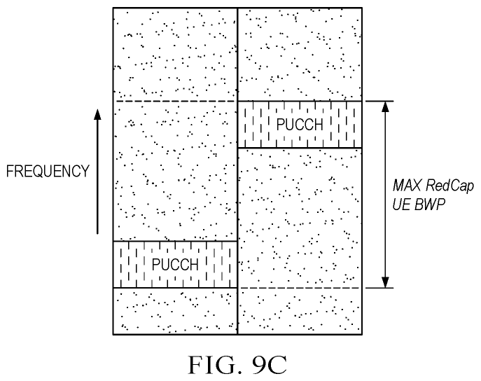

FIG. 9A-FIG. 9C show another approach to confine the PUCCH locations within a RedCap UE bandwidth and dynamically enabling/disabling frequency hopping. For example, 1 or 2 bits in the DCI can indicate to perform hopping. The network selects whether to use hopping according to traffic scheduled.

Examples of enabling/disabling hopping for 1-bit and 2-bit signaling in DCI are shown in Table 7.

TABLE 7
DCI signaling

| Value | Interpretation | Value | |
|---|---|---|---|
| ‘0’ | Enable hopping | ‘00’ | Enable hopping |
| ‘1’ | Disable hopping (PUCCH | ‘01’ | Disable hopping (PUCCH |
| | location based on location | | location based on location |
| | of first symbol of | | of first symbol) |
| | PUCCH) | | |
| | | ‘10’ | Disable hopping (PUCCH |
| | | | location based on location |
| | | | of second symbol) |
| | | ‘11’ | Reserved |

An alternative is to provide an appropriate entry in the pucch-ResourceId field that indicates whether frequency hopping is enabled (disabled). In the DCI, the PUCCH resource indicator provides an index to a RRC configured table. The network signals which entry a RedCap UE uses. The encoding/format of the values in the table can indicate whether to use hopping. Note that a RedCap UE and non-RedCap UE can have different table entries.

The benefit of enabling/disabling PUCCH hopping is that the network can enable hopping when there is no resource conflict and then maximize PUCCH performance. Disabling hopping is used when the network determines there is a resource conflict.

TABLE 8
Summary of possible BWPs for RedCap UEs

| | DL BWP | RACH BWP | PUSCH BWP | PUCCH BWP |
|---|---|---|---|---|
| Initial DL BWP | Same as non- | | | |
| for non- | RedCap UE, or | | | |
| RedCap UE ≤ | a BWP | | | |
| maximum BW | containing a | | | |
| for RedCap UE | CORESET | | | |
| Initial DL BWP | A BWP | | | |
| for non- | containing a | | | |
| RedCap UE > | CORESET | | | |
| maximum BW | | | | |
| for RedCap UE | | | | |
| Initial UL BWP | | Same as non- | Same as non- | Preferably |
| for non- | | RedCap UE, or | RedCap UE, or | same as |
| RedCap UE ≤ | | based on FDM | same as RACH | PUSCH BWP. |
| maximum BW | | RO | BWP, or a | Same as non- |
| for RedCap UE | | | dedicated BWP | RedCap UE, or |
| | | | | same as RACH |
| | | | | BWP, or a |
| | | | | dedicated BWP |
| Initial LL BWP | | based on FDM | Same as RACH | Preferably |
| for non- | | RO | BWP, or a | same as |
| RedCap UE > | | | dedicated BWP | PUSCH BWP. |
| maximum BW | | | | Same as RACH |
| for RedCap UE | | | | BWP, or a |
| | | | | dedicated BWP |

FIG. 10, flowchart 1000, shows the steps for establishing BWP for non-RedCap UEs. When the BWP size≤maximum BW of RedCap UE, the same steps can be used by a RedCap UE. After receiving the MIB, the UE establishes an initial DL BWP from CORESET #0 in step 1001. If network transmits a configuration for the initial DL BWP in the SIB, the UE overwrites the MIB-derived BWP in step 1002. In the third step, 1003, the UE establishes the initial UL BWP based on the configuration in the SIB. In step 4, 1004, the UE performs initial access uses in initial DL and UL BWP. If initial access is successful, the UE enters the connected state in the last step, 1005. There may be an RRC parameter exchange.

FIG. 10, flowchart 1010, shows the steps for establishing BWP for RedCap UEs. After receiving the MIB, the RedCap UE establishes an initial DL BWP from CORESET #0 in step 1011. In the second step, step 1012, if the UE received a configuration for the initial DL BWP in the SIB where the size of initial DL BWP for non-RedCap UE>maximum BW of RedCap UE, the RedCap UE can reuse the MIB-derived BWP or determine an initial DL BWP from a configuration for a RedCap UE. There may be SIB messaging or a definition. Note a RedCap UE can establish a BWP independent of the non-RedCap UE when the size of initial DL BWP for non-RedCap UE≤maximum BW of RedCap UE. In the third step, 1013, if the UE received a configuration for the initial UL BWP in the SIB where the size of initial UL BWP for non-RedCap UE>maximum BW of RedCap UE, the RedCap UE can establish a RACH and PUSCH BWP based on a separate SIB configuration or a definition based on the parameters for the non-RedCap UEs. Note a RedCap UE can establish a BWP independent of the non-RedCap UE when the size of initial UL BWP for non-RedCap UE≤maximum BW of RedCap UE. In the fourth step, 1014, the RedCap UE completes initial access with the established BWPs. Again, when the initial BWP is less than or equal to the maximum BW of RedCap UE, that initial BWP can be reused. If initial access is successful, the UE enters the connected state in the last step, 1015. There may be an RRC parameter exchange.

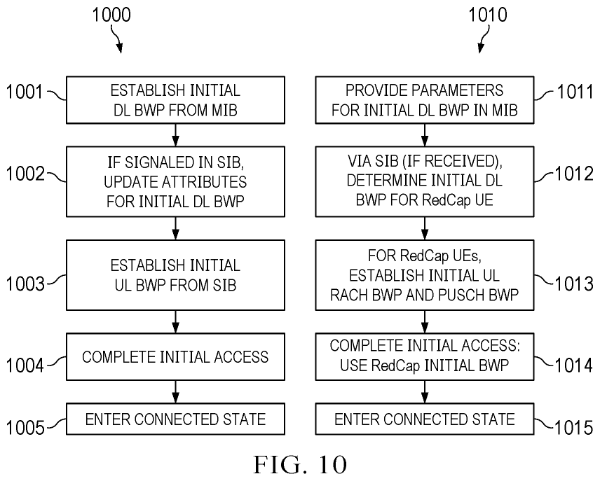

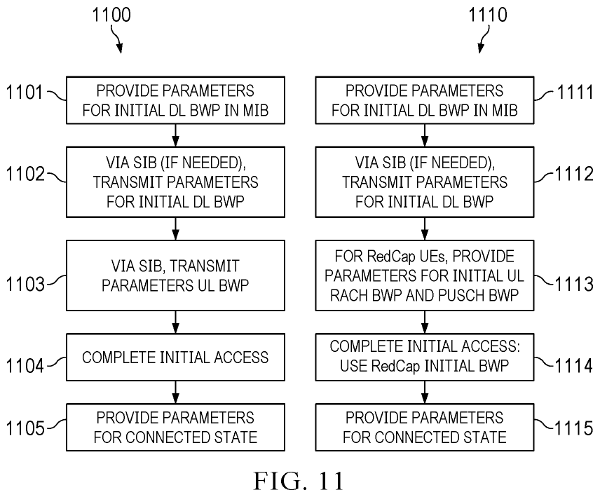

A companion base station (BS) operation is shown in FIG. 11. FIG. 11, flowchart 1100, shows the steps for initial access at a base station. In the first step, 1101, the base station transmits the MIB to provide a configuration for an initial DL BWP and CORESET #0. A base station can transmit a configuration for the initial DL BWP in the SIB, which can overwrite the MIB-derived BWP in 1102. In the third step, 1103, the transmission of the SIB can include parameters for the initial UL BWP and initial access (e.g. RACH parameters). In step 4, 1104, the base station can participate in the initial access procedure using the initial DL and UL BWPs. In step 5, 1105, if initial access with a UE was successful, the base station and UE can exchange RRC parameters. These parameters allow a UE to enter the connected state.

FIG. 11, flowchart 1110, shows the steps for the base station when RedCap UEs are present. In the first step, 1111, the base station transmits the MIB to provide a configuration for an initial DL BWP and CORESET #0. In the second step, 1112, the base station may transmit a configuration for the initial DL BWP for RedCap UEs in the SIB when the size of initial DL BWP for non-RedCap UE>maximum BW of RedCap UE. In the third step, 1113, the base station may transmit configuration parameters for the initial UL BWP in the SIB when the size of initial UL BWP for non-RedCap UE>maximum BW of RedCap UE. The base station can provide, for the RedCap UE, parameters for a RACH and PUSCH BWP based in a separate SIB configuration. In the fourth step, 1114, the base station completes initial access for RedCap UEs using the RedCap initial BWP. In step 5, 1115, if initial access with a RedCap UE was successful, the base station and RedCap UE can exchange RRC parameters. These parameters allow a RedCap UE to enter the connected state.

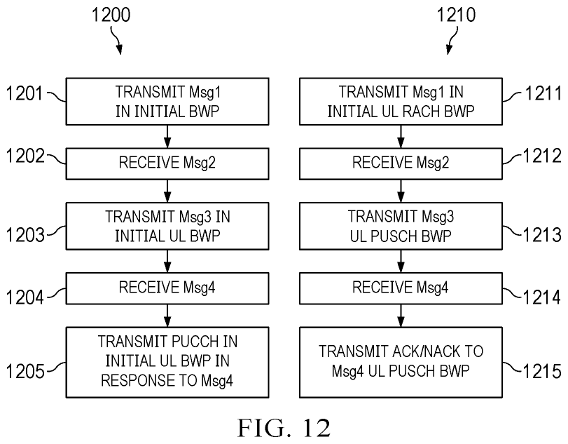

FIG. 12, flowchart 1200, shows the UL BWP for UEs during the initial process: applicable to non-RedCap UEs or when size of BWPs≤maximum BW of RedCap UE. In step 1, 1201, the UE transmits Msg1 in a RO located inside the initial UL BWP. After receiving Msg2 (including the PDCCH that schedules the PDSCH carrying Msg2) in step 2, 1202, the UE transmits Msg3 (PUSCH) inside the initial UL BWP in the third step, 1203. After receiving the PSDCH carrying Msg4 and the scheduling PDCCH that schedules this PDSCH in step 4, 1204, the UE transmits the PUCCH carrying the HARQ-ACK (indicating ACK/NACK) for Msg4. The resources of the particular PUCCH within the initial UL BWP are indicated in the scheduling DCI in step 5, 1205.

FIG. 12, flowchart 1210, shows the UL BWP for RedCap UEs during the initial process. It is assumed that initial UL BWP for non-RedCap UE>maximum BW of RedCap UE or that a RedCap UE established RACH and PUSCH even when initial UL BWP for non-RedCap UE≤maximum BW of RedCap UE. In step 1, 1211, the RedCap UE transmits Msg1 in a RO located inside the RACH BWP. In the third step, 1213, the RedCap UE transmits Msg3 inside the PUSCH BWP. In the last step, the UE transmits the PUCCH carrying the HARQ-ACK (indicating ACK/NACK) for Msg4. The resources of the particular PUCCH within the PUSCH BWP are indicated in the scheduling DCI in step 5, 1215.

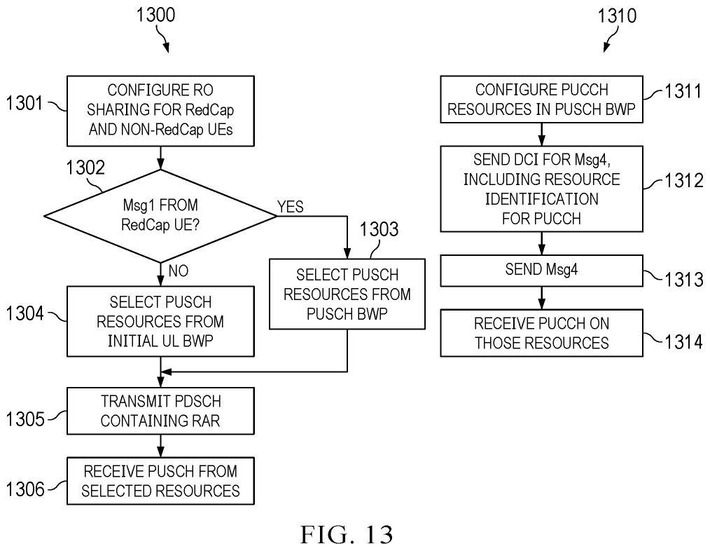

FIG. 13, flowchart 1300, shows the base station operation for Msg1 and Msg3 when RedCap and non-RedCap UEs share ROs. The first step, 1301, is configuring ROs that can be shared by RedCap and non-RedCap UEs. If a RedCap UE establishes a PUSCH BWP, when Msg1 is received, the base examines Msg1 to see if it from a RedCap UE, step 1302. It can be different root sequences or different set of preamble indices. If Msg1 is from a RedCap UE, the network sets resources within RAR from the PUSCH BWP, step 1303. Otherwise, the network sets resources for RAR from the initial UL BWP, step 1304. Since the base knows the resources it selected, it can receive Msg3, step 1306.

FIG. 13, flowchart 1310, shows the base station operation for the resources to receive the acknowledgement for Msg4 for RedCap UEs. The first step, 1311, is transmitting the configuration for a RedCap UE to establish a PUSCH BWP. In the DCI that schedules Msg4, the selected PUCCH resources are indicated to the UE in step 1312. After the transmission of Msg4, in step 1313, the base determines if the acknowledgement from the PUCCH was received on the selected resources in step 1314.

For NR mobile broadband (MBB), each PRB in the resource grid is defined as a slot of 14 consecutive orthogonal frequency division multiplexed (OFDM) symbols in the time domain and 12 consecutive subcarriers in the frequency domain, i.e., each resource block contains 12×14 resource elements (REs). When used as a frequency-domain unit, a PRB is 12 consecutive subcarriers. There are 14 symbols in a slot when a normal cyclic prefix is used and 12 symbols in a slot when an extended cyclic prefix is used. The duration of a symbol is inversely proportional to the subcarrier spacing (SCS). For a {15, 30, 60, 120} kHz SCS, the duration of a slot is {1, 0.5, 0.25, 0.125} ms, respectively. Each PRB may be allocated to combinations of a control channel, a shared channel, a feedback channel, reference signals, and so on. In addition, some REs of a PRB may be reserved. A similar structure is likely to be used on the SL as well. A communication resource may be a PRB, a set of PRBs, a code (if CDMA is used, similarly as for the physical uplink control channel (PUCCH)), a physical sequence, a set of REs, and so on.

FIG. 14 shows a part of a resource grid of 25 RBs in frequency and 7 symbols in time (A slot is 14 symbols in time). 25 RBs is an example of 5 MHz RF channel for 15 kHz SCS. The guard bands are omitted. The SSB can occupy 20 RBs in frequency and span 4 symbols. In FIG. 14, resource blocks 1402 represent the resource blocks of a 24-RB CORESET #0, 1404 is the primary synchronization signal (PSS) (10 RBs), 1406 is the secondary synchronization signal (SSS) (10 RBs), and 1408 is the PBCH. For a 20 RB SSB, the second and fourth symbols of the SSB have 20 RBs for the PBCH. In the third symbol, the 4 RBs before and after the SSS (in frequency) are used for the PBCH. 1410 represents an unoccupied RB. Also assume the REs are numbered from 0 to 11. The center of the SSB (RE #0 of the RB #10) is not necessarily aligned to RE #0 of a RB.

UEs transmit uplink control information (UCI) on the PUCCH resources, where the UCI can be combinations of HARQ-ACK feedback (acknowledgement (ACK)/negative acknowledgement (NACK)) in response to PDSCH transmissions (such as the ACK/NACK for Msg4), scheduling request (SR), and CSI reports. There are several PUCCH formats that can be used to accommodate the various sizes of UCI. There are procedures governing which format is used and what is conveyed in the UCI. Some examples are PUCCH format 0 and format 1.

During initial access, UEs are configured with the RRC parameter pucch-ResourceCommon which provides an index into a table. Each row of that table indicates which PUCCH format to use, the starting symbol of the start for the PUCCH resource (assuming normal cyclic prefix), the number of symbols used, the PRB offset (RB_{BWP}^{offset}) from edge of a BWP, and a set of cyclic shift indices (the number of elements in the set in N_{CS}). The size of the total PUCCH resources is 2·┌8/N_{cs}┐. For notation, let N=┌8/N_{CS}┐, and thus 2N RBs are available. Note there are 16 combinations of PRBs and cyclic shifts in a PUCCH resource. For example, if N_{CS}=2, there are 4 RBs with each RB having two cyclic shifts. There are 4 RBs located at the bottom of BWP and 4 RBs location at the top of the BWP. If N_{CS}=4, there are 2 RBs with each RB having four cyclic shifts.

There is a mapping rule to indicate which resource (PRB) and which cyclic shift to use (r_{PUCCH}modN_{CS} if r_{PUCCH}<8 and (r_{PUCCH}−8)modN_{CS} if r_{PUCCH}≥8. A brief description of the steps is shown in FIG. 15. The letters (a), (b), (c), and (d) are shown in Table 9 and used throughout. N_{RB} is number of RBs for a PUCCH resource set, and pucch-ResourceCommon provides this parameter for FR2-2, otherwise it is 1. N_{BWP}^{Size} is the size of the bandwidth part in RBs. For a PUCCH transmission, the procedure maps resources from one end (edge of BWP) in the first hop and from the opposite end (other edge of BWP) in the second hop. This hopping can be called intraslot frequency hopping.

$${r}_{PUCCH} = ⌊ \frac{2 \cdot {n}_{CCE , o}}{{N}_{C C E}} ⌋ + 2 \cdot {Δ}_{P R I} ( step 1 ) First compute {r}_{PUCCH} where$$

$${r}_{PUCCH} = ⌊ \frac{2 \cdot {n}_{CCE , o}}{{N}_{C C E}} ⌋ + 2 \cdot {Δ}_{P R I}$$

$${r}_{PUCCH} = ⌊ \frac{2 \cdot {n}_{CCE , o}}{{N}_{C C E}} ⌋ + 2 \cdot {Δ}_{P R I} {Δ}_{P R I} : PUCCH resource indicator [ 3 bits ]$$

$${r}_{PUCCH} = ⌊ \frac{2 \cdot {n}_{CCE , o}}{{N}_{C C E}} ⌋ + 2 \cdot {Δ}_{P R I} CCE index of PDCCH carrying scheduling information$$

$${r}_{PUCCH} = ⌊ \frac{2 \cdot {n}_{CCE , o}}{{N}_{C C E}} ⌋ + 2 \cdot {Δ}_{P R I} Number of CCEs available$$

$${r}_{PUCCH} = ⌊ \frac{2 \cdot {n}_{CCE , o}}{{N}_{C C E}} ⌋ + 2 \cdot {Δ}_{P R I} ( step 2 ) locate resources for first hop$$

$${r}_{PUCCH} = ⌊ \frac{2 \cdot {n}_{CCE , o}}{{N}_{C C E}} ⌋ + 2 \cdot {Δ}_{P R I} If {r}_{PUCCH} < 8 , lower index resource of BWP ( PUCCH a )$$

$${r}_{PUCCH} = ⌊ \frac{2 \cdot {n}_{CCE , o}}{{N}_{C C E}} ⌋ + 2 \cdot {Δ}_{P R I} If {r}_{PUCCH} \geq 8 , higher index resource of BWP ( PUCCH c )$$

$${r}_{PUCCH} = ⌊ \frac{2 \cdot {n}_{CCE , o}}{{N}_{C C E}} ⌋ + 2 \cdot {Δ}_{P R I} ( step 3 ) locate resources for second hop$$

$${r}_{PUCCH} = ⌊ \frac{2 \cdot {n}_{CCE , o}}{{N}_{C C E}} ⌋ + 2 \cdot {Δ}_{PRI} If {r}_{PUCCH} < 8 , higher index resource of BWP ( PUCCH b )$$

$${r}_{PUCCH} = ⌊ \frac{2 \cdot {n}_{CCE , o}}{{N}_{C C E}} ⌋ + 2 \cdot {Δ}_{P R I} If {r}_{PUCCH} \geq 8 , lower index resource of BWP ( PUCCH d )$$

TABLE 9
Mapping rules for PUCCH resources

| | | | BWP | |
|---|---|---|---|---|
| Hop | Label | r_{PUCCH} | location | Formula |
| First | PUCCH a | <8 | Low | RB_{BWP}^{offset} · N_{RB} + └r_{PUCCH}/N_{CS}┘ · N_{RB} |
| Second | PUCCH b | <8 | High | N_{BWP}^{size} − RB_{BWP}^{offset} · N_{RB} − (1 + └r_{PUCCH}/N_{CS}┘) · N_{RB} |
| First | PUCCH c | ≥8 | High | N_{BWP}^{size} − RB_{BWP}^{offset} · N_{RB} − (1 + └(r_{PUCCH} − 8)/N_{CS}┘) · N_{RB} |
| Second | PUCCH d | ≥8 | Low | RB_{BWP}^{offset} · N_{RB} + └(r_{PUCCH} − 8)/N_{CS}┘ · N_{RB} |

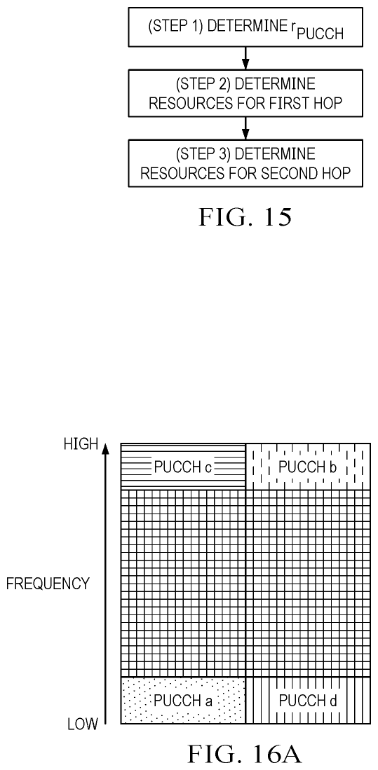

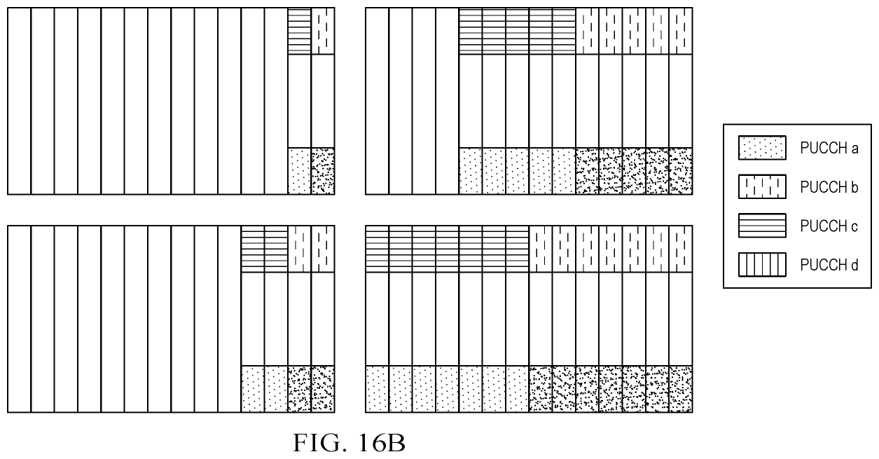

FIG. 16A shows a generic intraslot hopping pattern assuming RB_{BWP}^{offset}=0 and a two-symbol PUCCH allocation. In the figure, PUCCH a and PUCCH b are the first and second hops, respectively if r_{PUCCH}<8. PUCCH c and PUCCH d are the first and second hops, respectively if r_{PUCCH}≥8. The hopping patterns for 2, 4, 10, and 14 symbols are shown in FIG. 16B within a 14-symbol slot where the symbol numbering begins at 0. The sizes of PUCCH a, b, c, d are N=└8/N_{cs}┘ RBs. The subsequent figures are based on the two-symbol PUCCH, without a loss of generality for the other sizes (time domain size).

There are some benefits for placing the PUCCH on opposite ends of a BWP including a PUCCH performance benefit resulting from frequency diversity and maximizing the size of the available PUSCH for a second user while PUCCH is transmitted by a first user.

The mapping into the resources for hopping enabled is shown based on the equations in Table 9, assuming N_{RB}=1 in Table 10.

TABLE 10
Locations of resources N_{RB} = 1

| | | | | [r_{PUCCH}/8] = 0 | [r_{PUCCH}/8] = 1 |
|---|---|---|---|---|---|
| | PUCCH | | | Locations of resources: first hop; | Locations of resources: first hop; |
| Index | format | RB_{BWP}^{offset} | N_{cs} | second hop) | second hop) |
| 0 | 0 | 0 | 2 | {0, 1, 2, 3}; N_{BWP}^{size} − 1 − {0, 1, 2, 3} | N_{BWP}^{size} − 1 − {0, 1, 2, 3}; {0, 1, 2, 3} |
| 1 | 0 | 0 | 3 | {0, 1, 2}; N_{BWP}^{size} − 1 − {0, 1, 2, 3} | N_{BWP}^{size} − 1 − {0, 1, 2, 3}; {0, 1, 2} |
| 2 | 0 | 3 | 3 | 3 + {0, 1, 2}; N_{BWP}^{size} − 4 − {0, 1, 2} | N_{BWP}^{size} − 4 − {0, 1, 2}; 3 + {0, 1, 2} |
| 3 | 1 | 0 | 2 | {0, 1, 2, 3}; N_{BWP}^{size} − 1 − {0, 1, 2, 3} | N_{BWP}^{size} − 1 − {0, 1, 2, 3}; {0, 1, 2, 3} |
| 4 | 1 | 0 | 4 | {0, 1}; N_{BWP}^{size} − 1 − {0, 1} | N_{BWP}^{size} − 1 − {0, 1}; {0, 1} |
| 5 | 1 | 2 | 4 | 2 + {0, 1}; N_{BWP}^{size} − 3 − {0, 1} | N_{BWP}^{size} − 3 − {0, 1}; 2 + {0, 1} |
| 6 | 1 | 4 | 4 | 4 + {0, 1}; N_{BWP}^{size} − 5 − {0, 1} | N_{BWP}^{size} − 5 − {0, 1}; 4 + {0, 1} |
| 7 | 1 | 0 | 2 | {0, 1, 2, 3}; N_{BWP}^{size} − 1 − {0, 1, 2, 3} | N_{BWP}^{size} − 1 − {0, 1,2 ,3}; {0, 1, 2, 3} |
| 8 | 1 | 0 | 4 | {0, 1}; N_{BWP}^{size} − 1 − {0, 1} | N_{BWP}^{size} − 1 − {0, 1}; {0, 1} |
| 9 | 1 | 2 | 4 | 2 + {0, 1}; N_{BWP}^{size} − 3 − {0, 1} | N_{BWP}^{size} − 3 − {0, 1}; 2 + {0, 1} |
| 10 | 1 | 4 | 4 | 4 + {0, 1}; N_{BWP}^{size} − 5 − {0, 1} | N_{BWP}^{size} − 5 − {0, 1}; 4 + {0, 1} |
| 11 | 1 | 0 | 2 | {0, 1, 2, 3}; N_{BWP}^{size} − 1 − {0, 1, 2, 3} | N_{BWP}^{size} − 1 − {0, 1, 2, 3}; {0, 1, 2, 3} |
| 12 | 1 | 0 | 4 | {0, 1}; N_{BWP}^{size} − 1 − {0, 1} | N_{BWP}^{size} − 1 − {0, 1}; {0, 1} |
| 13 | 1 | 2 | 4 | 2 + {0, 1}; N_{BWP}^{size} − 3 − {0, 1} | N_{BWP}^{size} − 3 − {0, 1}; 2 + {0, 1} |
| 14 | 1 | 4 | 4 | 4 + {0, 1}; N_{BWP}^{size} − 5 − {0, 1} | N_{BWP}^{size} − 5 − {0, 1}; 4 + {0, 1} |
| 15 | 1 | └N_{BWP}^{size}/4┘ | 4 | └N_{BWP}^{size}/4┘ + {0, 1}; | N_{BWP}^{size} − 1 − └N_{BWP}^{size}/4┘ − {0, 1}; |
| | | | | N_{BWP}^{size} − 1 − └N_{BWP}^{size}/4┘ − {0, 1} | └N_{BWP}^{size}/4┘ + {0, 1} |

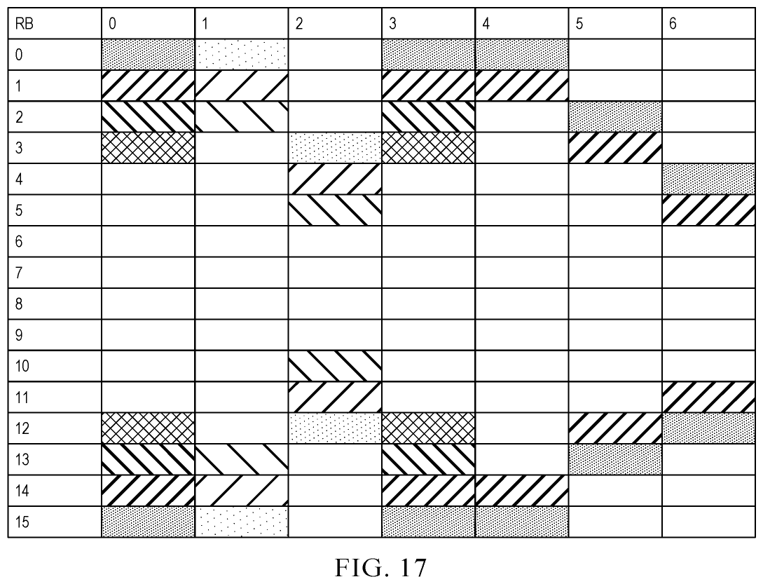

The mapping into RBs of a BWP with N_{BWP}^{size}=16 is shown in FIG. 17 for the first 7 indices of Table 10. In FIG. 17, the rows represent potential RBs occupied for a given index in Table 10. As an example, for index=0 in Table 10, for N_{CS}=2, the total resource allocation for PUCCH is 8 RBs, with 4 RBs allocated at RB positions 0 to 3 and another 4 RBs allocated at RB positions 12-15. If └r_{PUCCH}/N_{CS}┘=0, a UE would transmit PUCCH at locations 0 and 15. If └r_{PUCCH}/N_{CS}┘=1, a UE would transmit PUCCH at locations 1 and 14. If └r_{PUCCH}/N_{CS}┘=2, a UE would transmit PUCCH at locations 2 and 13. If └r_{PUCCH}/N_{CS}┘=3, a UE would transmit PUCCH at locations 3 and 12.

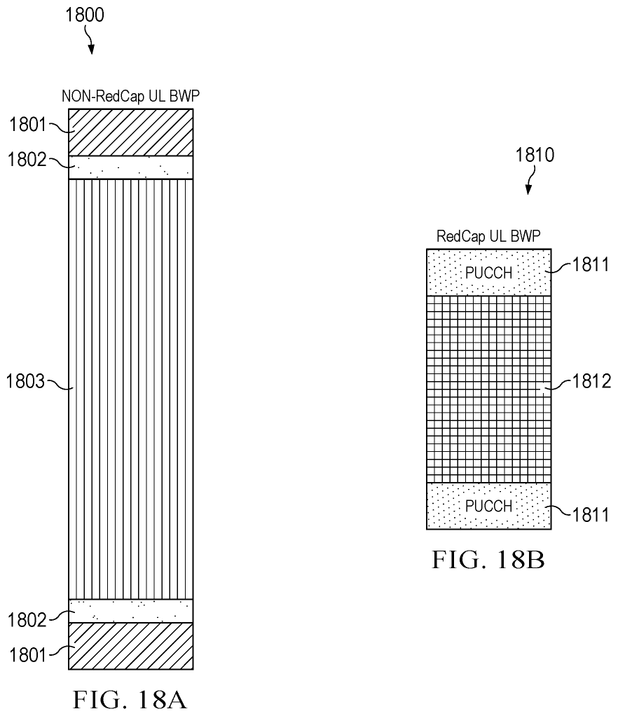

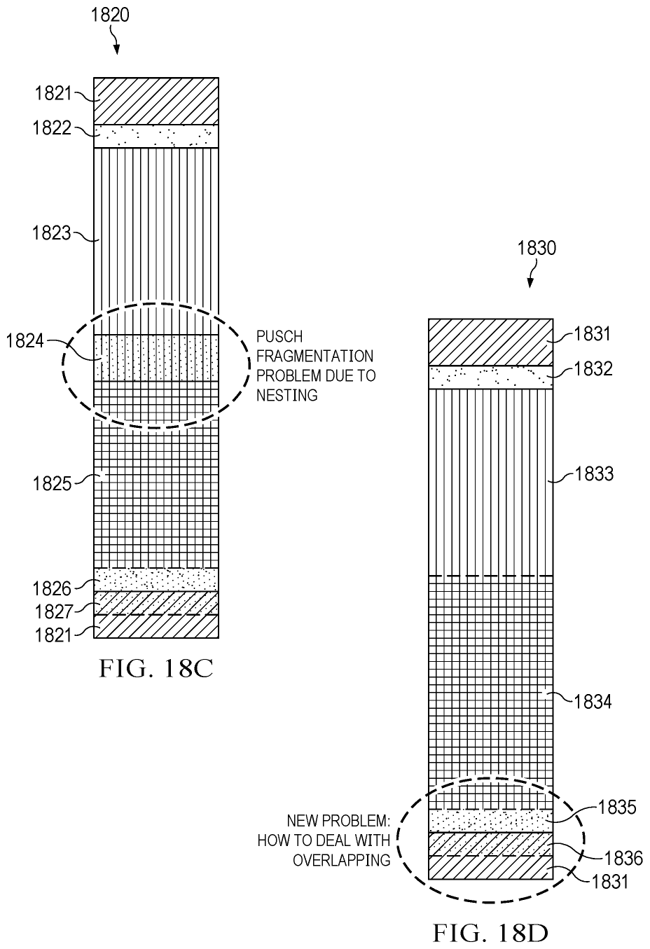

A UE can be configured with one or more BWP in each direction of the link, with one active BWP in each direction. During idle/inactive states (RRC_IDLE/RRC_INACTIVE), a UE can have a MIB-configured initial DL BWP. That may be overwritten by a SIB-configured initial DL BWP. A UE receives a configuration for initial UL BWP, 1800. The location of the PUCCH resources 1801 is shown in FIG. 18A. One or more UEs may transmit PUSCH in region 1803. Region 1802 may not contain any UE transmission. The issue is the size of the initial UL BWP can exceed the maximum bandwidth for a RedCap UE. As shown in FIG. 18B, to resolve this issue, a RedCap UE can be configured with a separate initial UL BWP 1810 with a size no greater that the maximum bandwidth for a RedCap UE. As a result, the PUCCH resources for RedCap UE, 1811 are located within the separate initial UL BWP, as shown in FIG. 18B. One or more RedCap UEs may transmit PUSCH in region 1812.

From a base station perspective, both the initial UL BWP (or in general any active UL BWP), 1800 and separate initial UL BWP, 1810, can overlap at the same time, as shown in FIG. 18C, 1820. When looking at this overlap, the location of the PUCCH resources, 1824 and 1826, for RedCap UEs can be located within the UL BWP 1820 (for non-RedCap UEs). If a base station schedules a PUSCH, 1823, for a non-RedCap UE at the same time it expects to receive a PUCCH transmission in 1824 and/or 1826 from a RedCap UE, the size of the PUSCH allocation, 1823, may be restricted to avoid resource collisions from a PUSCH transmission, 1823, and PUCCH transmission, 1824. This issue can be called PUSCH fragmentation. PUCCH resources, 1821, for non-RedCap UEs may overlap with PUCCH resources, 1826, for RedCap UEs as seen in 1827. A base station can receive PUSCH 1825 from either RedCap or non-RedCap UEs. Region 1822 may contain no transmissions.

The problem of PUSCH fragmentation can be addressed by allowing the network to disable/deactivate PUCCH frequency hopping. In case a separate initial UL BWP is configured for RedCap UEs, the network can enable/disable intra-slot PUCCH frequency hopping within the separate initial UL BWP in the PUCCH resource for HARQ feedback for Msg4/MsgB for RedCap UEs. The frequency hopping can be enabled/disabled at least via SIB.

From a base station perspective, there is still a potential overlap of PUCCH resources between RedCap and non-RedCap UEs as shown in FIG. 18C and FIG. 18D. As shown in FIG. 18D, 1830, PUCCH resources, 1835, for RedCap UEs can still overlap with PUCCH resources, 1831, for non-RedCap UEs in region 1836, even with hopping disabled. By disabling hopping, a non-RedCap UE can transmit PUSCH 1833 without being restricted in size (PUSCH fragmentation is mitigated). A base station can receive PUSCH 1834 from either RedCap or non-RedCap UEs. Region 1832 may contain no transmissions. There are two problems related to disabling frequency hopping: identifying where to place the PUCCH resources (either the top half or bottom half of the separate initial UL BWP) and how to locate the resources within the selected half. The following agreement in RAN1 #107 highlights the status of the resource mapping.

There are two types of overlapping PUCCH resources:
For RedCap UEs when frequency hopping is disabled: If there are 2N PUCCH resources (RBs) where N is the number of RBs on one end of BWP, determine the mapping rule for (a, b, c, d) and if each N-sized resource located next to each other.
Between RedCap and non-RedCap UEs: determine options to separate resources.

The general problem is the mapping rule for PUCCH resources for RedCap UEs when frequency hopping is disabled, and if frequency hopping is still enabled, applicability to the active state. The rules are for initial access. These mapping rules can be applicable to the active state.

In general, when a RedCap UE is configured to disable frequency hopping, the UE does not know which half of the separate initial UL BWP to locate the PUCCH resources (i.e., bottom/lower half/low numbered RBs vs. top/upper/higher half/high numbered RBs). There may be several ways for a RedCap UE to know which half.

a) Absence of the disable frequency hopping flag vs. the presence of the frequency disabled flag which indicates which half to use.

Example: an RRC configuration indicating which half of the separate initial UL BWP to use (for instance flagPUCCH ResourceHalf which is an enumeration of top and bottom. The flag is optional if hopping is enabled (default).

If flagPUCCHResourceHalf not configured:
frequency hopping is enabled (default)

### Else:

frequency hopping is disabled
if flagPUCCHResourceHalf==top:
   PUCCH resources located at upper half of BWP
Else:
   PUCCH resources located at lower half of BWP

b) Two flags: disable frequency hopping (disablePUCCHFrequencyHop) and flag which half to use

If disablePUCCHFrequencyHop==True:
frequency hopping is disabled
if flagPUCCHResourceHalf==top:
   PUCCH resources located at upper half of BWP Else:
   PUCCH resources located at lower half of BWP

c) One flag and an offset value (where the offset value is to address overlapping PUCCH resources between RedCap and non-RedCap UEs). Note this offset value can be used to address overlapping PUCCH resources between RedCap and non-RedCap UEs even when frequency hopping is enabled (default operation).

If disablePUCCHFrequencyHop==True:
frequency hopping is disabled
if offsetvalue<size BWP/2:
   PUCCH resources located at lower half of BWP
   Offset2=offsetvalue
Else:
   PUCCH resources located at upper half of BWP
   Offset2=size BWP−offsetvalue

d) Setting r_{PUCCH} to be less than 8 for the lower half and r_{PUCCH} to be 8 or higher for the upper half when frequency hopping is disabled. This is real-time signaling because the gNB must select the Δ_{PRI} value and the CCE index to use in the r_{PUCCH} calculation This also reduces the capacity of PUCCH resources from 16 down to 8.

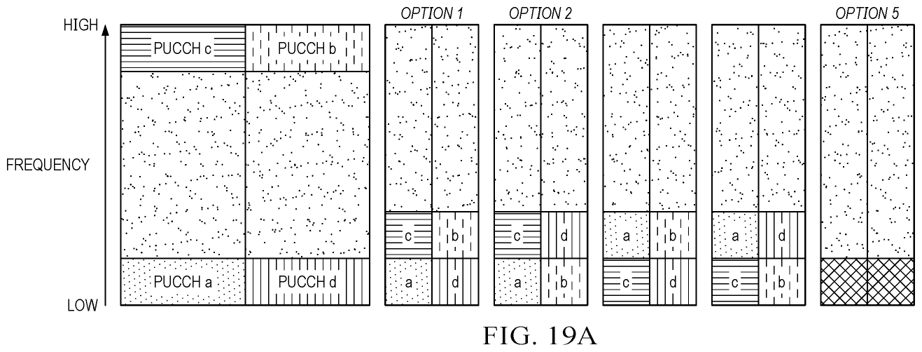

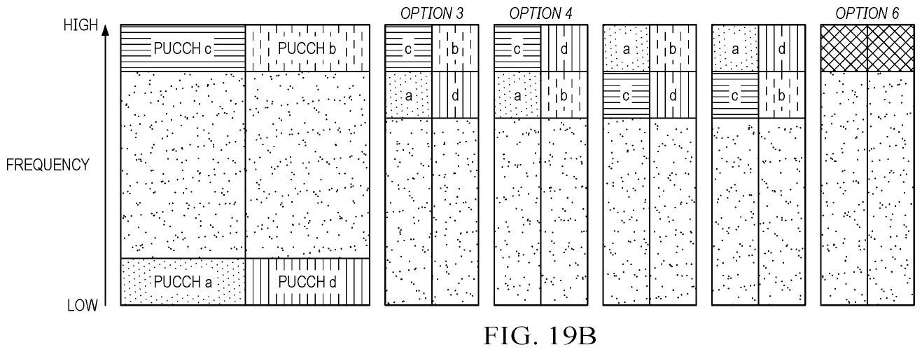

As Table 9 indicates, there are four equations for identifying the PUCCH resources. For convenience, they are labeled a, b, c, d and their relative location with respect to time and frequency is shown in FIG. 19A and FIG. 19B. In all the figures, RB_{BWP}^{offeset}=0. When frequency hopping is disabled and when 2N resources are used for PUCCH, there are four possible arrangements: [symbol 0, symbol 1] where (x,y) with x indicating the lower number PRB location: [(a,c), (d,b)]; [(a,c), (b,d)]; [(c,a), (d,b)]; [(c,a), (b,d)].

For FIG. 19A, (option 1) the first arrangement [(a,c), (d,b)] is the current mapping without placing the resources at either end of the BWP. The second arrangement (option 2) places (r_{PDCCH}<8) in the lower numbered PRB locations. The third arrangement places (r_{PDCCH}>8) in the lower numbered PRB locations. The last arrangement is a flip of the first arrangement. Option 5 is mapping r_{PUCCH} into resources at one end.

For FIG. 19B, the first arrangement [(a,c), (d,b)] is the current mapping without placing the resources at either end of the BWP. The second arrangement (option 3) places (r_{PDCCH}<8) in the lower-numbered PRB locations at the top RBs of the BWP. The third arrangement (option 4) places (r_{PDCCH}≥8) in the lower-numbered PRB locations. The last arrangement is a flip of the first arrangement.

Options 5/6 in FIG. 19A-FIG. 19B can be the result of using N resources and aliasing r_{PDCCH} and r_{PDCCH}−8; using N resources and mapping r_{PDCCH}<8 to the lower half and r_{PDCCH}≥8 (related to d in previous section).

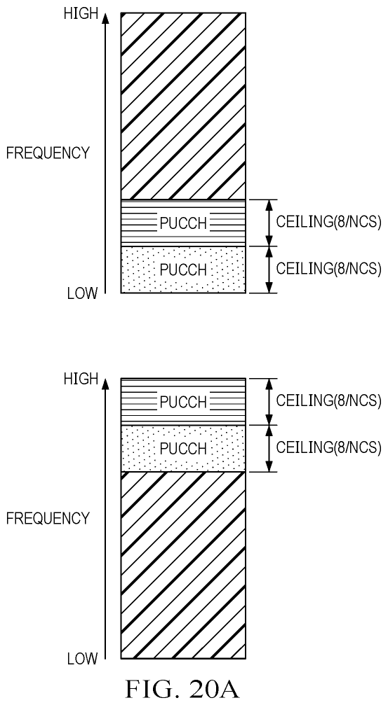

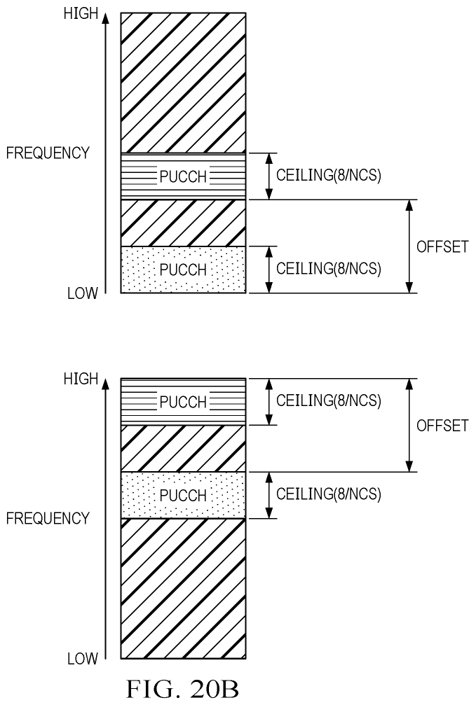

For the following, option 1 to option 4 in FIG. 19A-FIG. 19B are examined in terms of equations in Table 11. The value offset is shown in FIG. 20A and FIG. 20B. For adjacent PUCCH resources, the offset value should be └8/N_{CS}┘. The value can be signaled or stated directly in the standard.

TABLE 11
Mapping rules for PUCCH resources

| Option | Hop | Label | r_{PUCCH} | Formula |
|---|---|---|---|---|
| 1 | First | a | <8 | RB_{BWP}^{offset} · N_{RB} + └r_{PUCCH}/N_{CS}┘ · N_{RB} |
| 1 | Second | b | <8 | (RB_{BWP}^{offset} + offset) · N_{RB} + └r_{PUCCH}/N_{CS}┘ · N_{RB} |
| 1 | First | c | ≥8 | (RB_{BWP}^{offset} + offset) · N_{RB} + └(r_{PUCCH} − 8)/N_{CS}┘ · N_{RB} |
| 1 | Second | d | ≥8 | RB_{BWP}^{offset} · N_{RB} + └(r_{PUCCH} − 8)/N_{CS}┘ · N_{RB} |
| 2 | First | a | <8 | RB_{BWP}^{offset} · N_{RB} + └r_{PUCCH}/N_{CS}┘ · N_{RB} |
| 2 | Second | b | <8 | RB_{BWP}^{offset} · N_{RB} + └r_{PUCCH}/N_{CS}┘ · N_{RB} |
| 2 | First | c | ≥8 | (RB_{BWP}^{offset} + offset) · N_{RB} + └(r_{PUCCH} − 8)/N_{CS}┘ · N_{RB} |
| 2 | Second | d | ≥8 | (RB_{BWP}^{offset} + offset) · N_{RB} + └(r_{PUCCH} − 8)/N_{CS}┘ · N_{RB} |
| 3 | First | a | <8 | N_{BWP}^{size} − (RB_{BWP}^{offset} + offset) · N_{RB} − (1 + └r_{PUCCH}/N_{CS}┘) · N_{RB} |
| 3 | Second | b | <8 | N_{BWP}^{size} − RB_{BWP}^{offset} · N_{RB} − (1 + └r_{PUCCH}/N_{CS}┘) · N_{RB} |
| 3 | First | c | ≥8 | N_{BWP}^{size} − RB_{BWP}^{offset} · N_{RB} − (1 + └r_{PUCCH} − 8)/N_{CS}┘) · N_{RB} |
| 3 | Second | d | ≥8 | N_{BWP}^{size} − (RB_{BWP}^{offset} + offset) · N_{RB} − (1 + └r_{PUCCH}/N_{CS}┘) · N_{RB} |
| 4 | First | a | <8 | N_{BWP}^{size} − (RB_{BWP}^{offset} + offset) · N_{RB} − (1 + └r_{PUCCH}/N_{CS}┘) · N_{RB} |
| 4 | Second | b | <8 | N_{BWP}^{size} − (RB_{BWP}^{offset} + offset) · N_{RB} − (1 + └r_{PUCCH}/N_{CS}┘) · N_{RB} |
| 4 | First | c | ≥8 | N_{BWP}^{size} − RB_{BWP}^{offset} · N_{RB} − (1 + └(r_{PUCCH} − 8)/N_{CS}┘) · N_{RB} |
| 4 | Second | d | ≥8 | N_{BWP}^{size} − RB_{BWP}^{offset} · N_{RB} − (1 + └(r_{PUCCH} − 8)/N_{CS}┘) · N_{RB} |

This embodiment shows how each N RB PUCCH resource is positioned with respect to each other. In FIG. 20A, the first and second PUCCH resources are adjacent in frequency The offset is └8/N_{CS}┘. In FIG. 20B, the offset is greater than └8/N_{CS}┘. The offset can be implicit in the standard (e.g. set to └8/N_{CS}┘) or signaled (RRC signaling).

Note that the current agreement is disabling frequency hopping is applicable for RedCap UEs during initial access. It is possible to extend this mapping when disabling frequency hopping is applicable during the active state or with devices with limited bandwidth. For use during initial access, it may be beneficial to ensure that all RedCap UEs support disabling frequency hopping. Though the feature is optional for an arbitrary UE, it is then designated as a “must support” component in the feature description for certain UE types. Alternatively, disabling frequency hopping and the associated operations may be provided a feature group and signaling just for the disabling frequency hopping, and UE of various types indicates that the feature group is a pre-requisite for operation. In this way, RedCap UEs of various releases or non-RedCap UEs (of normal or e.g. 3 MHz bandwidth) also can indicate support for the feature group. Another benefit of this approach is that the feature group may be designated as mandatory with capability signaling, which can be set to supported when testing of devices is available.

In general, PUCCH resources are multiplexed for RedCap and non-RedCap UEs in time (first hop/second hop) (based on r_{PUCCH}); time (through the use of TDRA tables); frequency; and cyclic shift (based on r_{PUCCH}). To avoid PUCCH resources overlapping in frequency, the starting/ending location of RedCap UL BWP is chosen to avoid any overlap. There may be some sharing issues for other resources. When the starting/ending location of RedCap UL BWP is within the PUCCH resources for the non-RedCap UE, a different value of pucch-ResourceCommon is provided to the RedCap UE so that its PUCCH resources do not overlap. The approach may not be viable depending on the amount of overlap and the number of Ncs used for each RedCap and non-RedCap UE configuration. Note the agreement supports this approach. Another approach is using an offset (offset2) signaled in RRC.

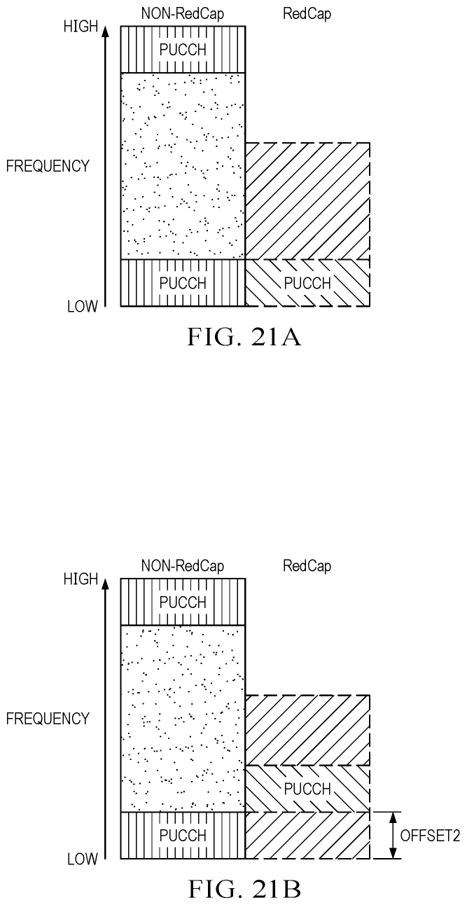

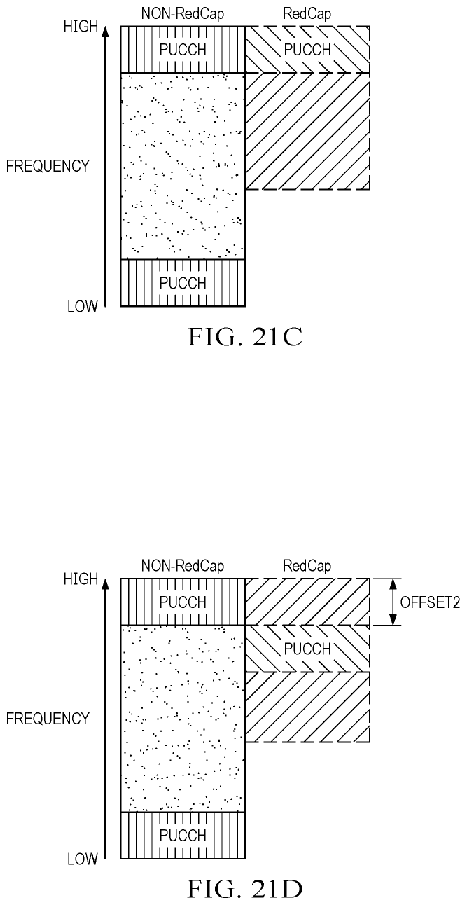

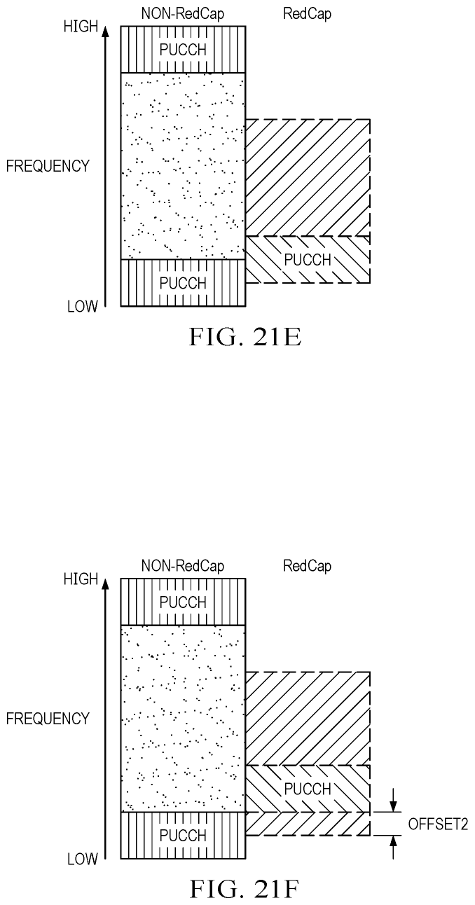

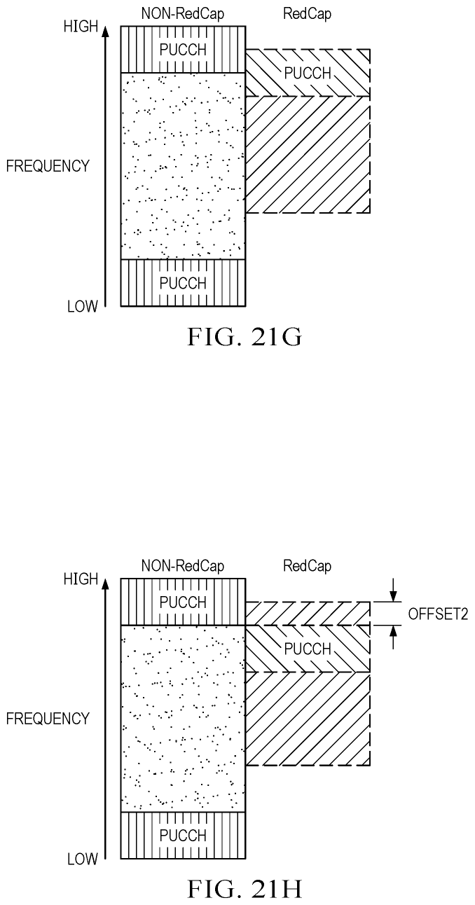

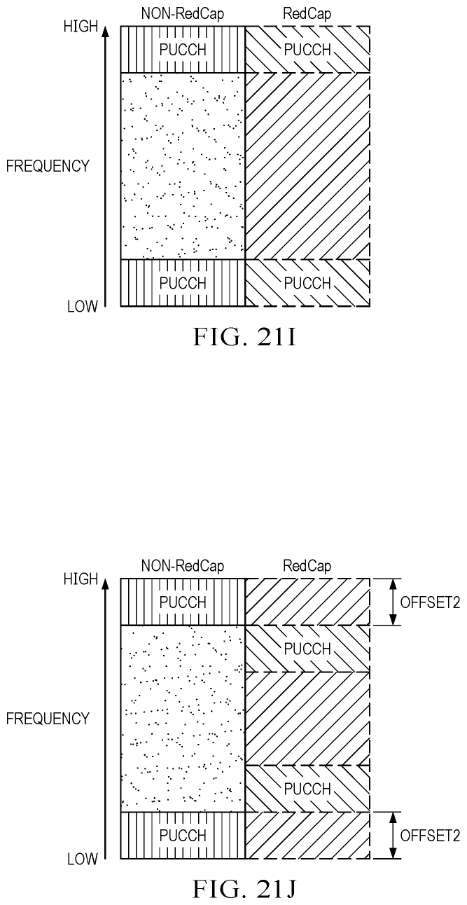

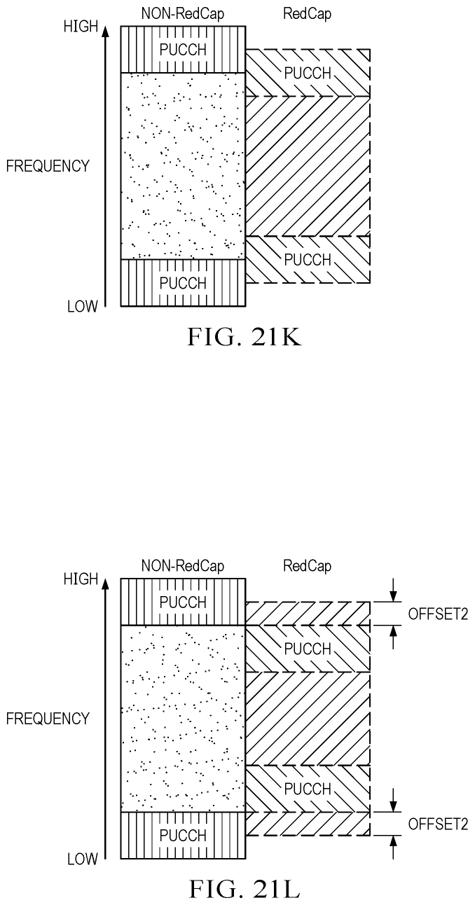

In FIG. 21A-FIG. 21L, there are several scenarios that show where PUCCH resources for RedCap and non-RedCap UEs overlap: In FIG. 21A, the BWPs are aligned at the bottom with frequency hopping disabled for RedCap UEs; in FIG. 21B, offset2 is introduced to avoid overlap as shown in FIG. 21A. In FIG. 21C, the BWPs are aligned at the top with frequency hopping disabled for RedCap UEs; in FIG. 21D, offset2 is introduced to avoid overlap as shown in FIG. 21C. In FIG. 21E, the bottom of the UL BWP for RedCap UEs is located within the PUCCH resource for non-RedCap UEs with frequency hopping disabled for RedCap UEs; in FIG. 21F, offset2 is introduced to avoid overlap as shown in FIG. 21E. In FIG. 21G, the top of the UL BWP for RedCap UEs is located within the PUCCH resource for non-RedCap UEs with frequency hopping disabled for RedCap UEs; in FIG. 21H, offset2 is introduced to avoid overlap as shown in FIG. 21G. In FIG. 21I, the BWPs are aligned; in FIG. 21J, offset2 is introduced to avoid overlap as shown in FIG. 21H In FIG. 21K, both the top and bottom of the UL BWP for RedCap UEs are within the PUCCH resources for the non-RedCap UEs. in FIG. 21L, offset2 is introduced to avoid overlap as shown in FIG. 21K. There can be other scenarios possible. The various uses of offset2 can avoid the PUCCH resources for RedCap UEs from overlapping with PUCCH resources for non-RedCap UEs. An example how offset2 can be used for PUCCH (option 1 (a) in Table 11) is presented in Table 12.

TABLE 12
Use of offset2 to separate PUCCH resources for RedCap and non-RedCap UEs.

| BWP | r_{PUCCH} | Formula |
|---|---|---|
| Low | <8 | (RB_{BWP}^{offset} + offset2) · N_{RB} + └r_{PUCCH}/N_{CS}┘ · N_{RB} |
| Low | ≥8 | (RB_{BWP}^{offset} + offset2) · N_{RB} + └(r_{PUCCH} − 8)/N_{CS}┘ · N_{RB} |
| High | <8 | N_{BWP}^{size} − (RB_{BWP}^{offset} + offset2) · N_{RB} − (1 + └r_{PUCCH}/N_{CS}┘) · N_{RB} |
| High | ≥8 | N_{BWP}^{size} − (RB_{BWP}^{offset} + offset2) · N_{RB} − (1 + └(r_{PUCCH} − 8)/N_{CS}┘) · N_{RB} |

As shown in FIG. 21H and FIG. 21J, the embodiment is applicable even if frequency hopping is enabled. This embodiment can be used even when the RedCap UE is in the active state. For example, receiving a configuration for transmitting uplink control information (UCI) in a physical uplink control channel (PUCCH) comprising an indicator to disable PUCCH frequency hopping and a first offset applied to determine the location of PUCCH resources, and transmitting the UCI in the PUCCH in accordance with the indicator indicating PUCCH frequency hopping is disabled, wherein the location of the PUCCH resources includes the first offset can be used when the RedCap UE is in the active state.

It is possible to combine the embodiments for the location of PUCCH resources when frequency hopping is disabled for RedCap UEs and location of PUCCH resources when PUCCH resources for RedCap and non-RedCap UEs overlap. The following example shows a text proposal combining options 1 and 3 in FIG. 19A and FIG. 19B, FIG. 20A, and location of PUCCH resources when PUCCH resources for RedCap and non-RedCap UEs overlap.

If └r_{PUCCH}/8┘=0,
if flag-BWP indicates low, the UE determines the lowest PRB index of the PUCCH transmission as (RB_{BWP}^{offset}+offset2)·N_{RB}+└r_{PUCCH}/N_{CS}┘·N_{RB} for the first hop and (RB_{BWP}^{offset}+offset2+└8/N_{CS}┘)·N_{RB}+└r_{PUCCH}/N_{CS}┘·N_{RB} for the second hop; otherwise, the lowest PRB index of the PUCCH transmission is N_{BWP}^{size}−(RB_{BWP}^{offset}+offset2+└8/N_{CS}┘)·N_{RB}−(1+└r_{PUCCH}/N_{CS}┘)·offset+offset2)·N_{RB}−(1+└r_{PUCCH}/N_{CS}┘)·N_{RB} for the N_{RB} for the first hop and N_{BWP}^{size}−(RB_{BWP}^{offset}+offset2)·N_{RB}−(1+└r_{PUCCH}/N_{CS}┘)·N_{RB} for the second hop.

If └r_{PUCCH}/8┘=1,
if flag-BWP indicates low, the UE determines the lowest PRB index of the PUCCH transmission as (RB_{BWP}^{offset}+offset2+└8/N_{CS}┘)·N_{RB}+(└(r_{PUCCH}−8)/N_{CS}┘)·N_{RB} for the first hop and (RB_{BBWP}^{offset}+offset2)·N_{RB}+(└(r_{PUCCH}−8)/N_{CS}┘)·N_{RB}, otherwise, the lowest PRB index of the PUCCH transmission is N_{BWP}^{size}−(RB_{BWP}^{offset}+offset2)·N_{RB}−(1+└(r_{PUCCH}−8)/N_{CS}┘)·N_{RB} for the first hop and N_{BWP}^{size}−(RB_{BWP}^{offset}+offset2+└8/N_{CS}┘)·N_{RB}−(1+└(r_{PUCCH}−8)/N_{CS}┘)·N_{RB}

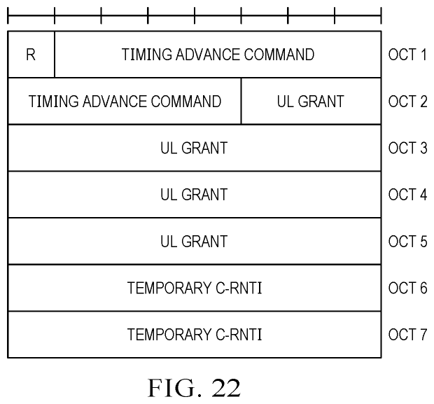

For reference, the MAC payload (TS 38.331, clause 6.2.3), is described. The MAC RAR is of fixed size as depicted in FIG. 22, and consists of the following fields:
R: Reserved bit, set to “0”;
Timing Advance Command: The Timing Advance Command field indicates the index value T_{A} used to control the amount of timing adjustment that the MAC entity has to apply in TS 38.213. The size of the Timing Advance Command field is 12 bits;
UL Grant: The Uplink Grant field indicates the resources to be used on the uplink in TS 38.213. The size of the UL Grant field is 27 bits;
Temporary C-RNTI: The Temporary C-RNTI field indicates the temporary identity that is used by the MAC entity during Random Access. The size of the Temporary C-RNTI field is 16 bits.

The MAC RAR is octet aligned.

For reference, the scheduling parameters for Msg3 are shown below. This table corresponds to the UL grant in FIG. 22.

TABLE 13
Random Access Response Grant Content field size (from 38.213)

| RAR grant field | Number of bits |
|---|---|
| Frequency hopping flag | 1 |
| PUSCH frequency resource | 14, for operation without shared |
| allocation | spectrum channel access |
| | 12, for operation with shared |
| | spectrum channel access |
| PUSCH time resource allocation | 4 |
| MCS | 4 |
| TPC command for PUSCH | 3 |
| CSI request | 1 |
| ChannelAccess-CPext | 0, for operation without shared |
| | spectrum channel access |
| | 2, for operation with shared |
| | spectrum channel access |

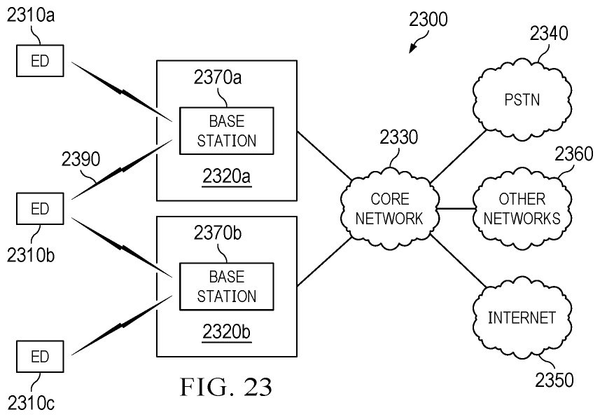

FIG. 23 illustrates an example communication system 2300. In general, the system 2300 enables multiple wireless or wired users to transmit and receive data and other content. The system 2300 may implement one or more channel access methods, such as code division multiple access (CDMA), time division multiple access (TDMA), frequency division multiple access (FDMA), orthogonal FDMA (OFDMA), single-carrier FDMA (SC-FDMA), or non-orthogonal multiple access (NOMA).

In this example, the communication system 2300 includes electronic devices (ED) 2310a-2310c, radio access networks (RANs) 2320a-2320b, a core network 2330, a public switched telephone network (PSTN) 2340, the Internet 2350, and other networks 2360. While certain numbers of these components or elements are shown in FIG. 23, any number of these components or elements may be included in the system 2300.

The EDs 2310a-2310c are configured to operate or communicate in the system 2300. For example, the EDs 2310a-2310c are configured to transmit or receive via wireless or wired communication channels. Each ED 2310a-2310c represents any suitable end user device and may include such devices (or may be referred to) as a user equipment or device (UE), wireless transmit or receive unit (WTRU), mobile station, fixed or mobile subscriber unit, cellular telephone, personal digital assistant (PDA), smartphone, laptop, computer, touchpad, wireless sensor, or consumer electronics device.

The RANs 2320a-2320b here include base stations 2370a-2370b, respectively. Each base station 2370a-2370b is configured to wirelessly interface with one or more of the EDs 2310a-2310c to enable access to the core network 2330, the PSTN 2340, the Internet 2350, or the other networks 2360. For example, the base stations 2370a-2370b may include (or be) one or more of several well-known devices, such as a base transceiver station (BTS), a Node-B (NodeB), an evolved NodeB (eNodeB), a Next Generation (NG) NodeB (gNB), a Home NodeB, a Home eNodeB, a site controller, an access point (AP), or a wireless router. The EDs 2310a-2310c are configured to interface and communicate with the Internet 2350 and may access the core network 2330, the PSTN 2340, or the other networks 2360.

In the embodiment shown in FIG. 23, the base station 2370a forms part of the RAN 2320a, which may include other base stations, elements, or devices. Also, the base station 2370b forms part of the RAN 2320b, which may include other base stations, elements, or devices. Each base station 2370a-2370b operates to transmit or receive wireless signals within a particular geographic region or area, sometimes referred to as a “cell.” In some embodiments, multiple-input multiple-output (MIMO) technology may be employed having multiple transceivers for each cell.

The base stations 2370a-2370b communicate with one or more of the EDs 2310a-2310c over one or more air interfaces 2390 using wireless communication links. The air interfaces 2390 may utilize any suitable radio access technology.

It is contemplated that the system 2300 may use multiple channel access functionality, including such schemes as described above. In particular embodiments, the base stations and EDs implement 5G New Radio (NR), LTE, LTE-A, or LTE-B. Of course, other multiple access schemes and wireless protocols may be utilized.

The RANs 2320a-2320b are in communication with the core network 2330 to provide the EDs 2310a-2310c with voice, data, application, Voice over Internet Protocol (VOIP), or other services. Understandably, the RANs 2320a-2320b or the core network 2330 may be in direct or indirect communication with one or more other RANs (not shown). The core network 2330 may also serve as a gateway access for other networks (such as the PSTN 2340, the Internet 2350, and the other networks 2360). In addition, some or all of the EDs 2310a-2310c may include functionality for communicating with different wireless networks over different wireless links using different wireless technologies or protocols. Instead of wireless communication (or in addition thereto), the EDs may communicate via wired communication channels to a service provider or switch (not shown), and to the Internet 2350.

Although FIG. 23 illustrates one example of a communication system, various changes may be made to FIG. 23. For example, the communication system 2300 could include any number of EDs, base stations, networks, or other components in any suitable configuration.

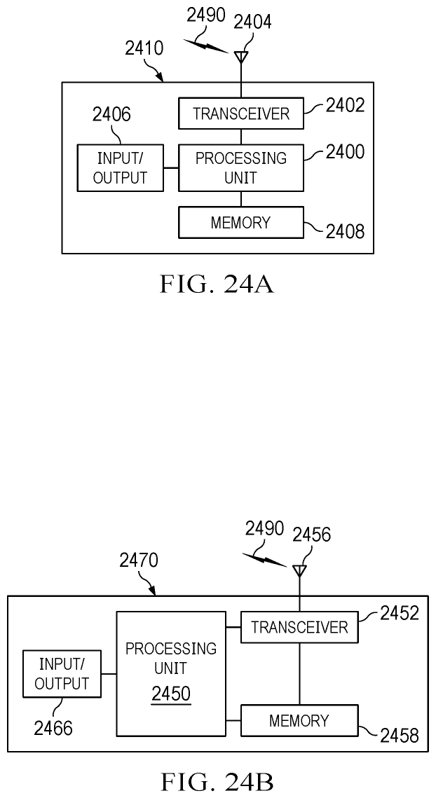

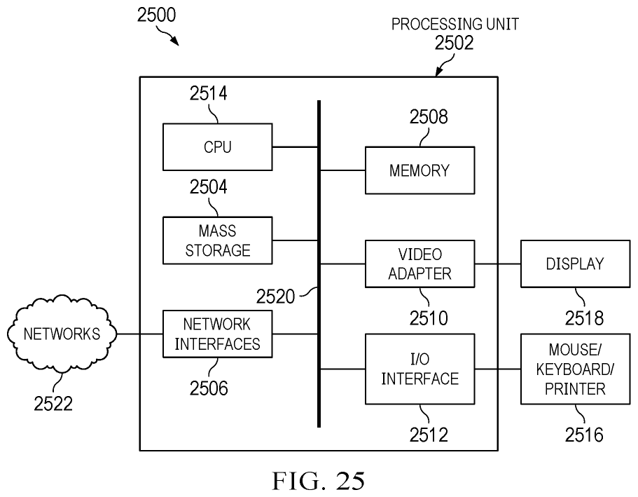

FIGS. 24A and 24B illustrate example devices that may implement the methods and teachings according to this disclosure. In particular, FIG. 24A illustrates an example ED 2510, and FIG. 24B illustrates an example base station 2570. These components could be used in the system 2300 or in any other suitable system.

As shown in FIG. 24A, the ED 2510 includes at least one processing unit 2500. The processing unit 2500 implements various processing operations of the ED 2510. For example, the processing unit 2500 could perform signal coding, data processing, power control, input/output processing, or any other functionality enabling the ED 2510 to operate in the system 2300. The processing unit 2500 also supports the methods and teachings described in more detail above. Each processing unit 2500 includes any suitable processing or computing device configured to perform one or more operations. Each processing unit 2500 could, for example, include a microprocessor, microcontroller, digital signal processor, field programmable gate array, or application specific integrated circuit.

The ED 2510 also includes at least one transceiver 2502. The transceiver 2502 is configured to modulate data or other content for transmission by at least one antenna or NIC (Network Interface Controller) 2504. The transceiver 2502 is also configured to demodulate data or other content received by the at least one antenna 2504. Each transceiver 2502 includes any suitable structure for generating signals for wireless or wired transmission or processing signals received wirelessly or by wire. Each antenna 2504 includes any suitable structure for transmitting or receiving wireless or wired signals. One or multiple transceivers 2502 could be used in the ED 2510, and one or multiple antennas 2504 could be used in the ED 2510. Although shown as a single functional unit, a transceiver 2502 could also be implemented using at least one transmitter and at least one separate receiver.

The ED 2510 further includes one or more input/output devices 2506 or interfaces (such as a wired interface to the Internet 2350). The input/output devices 2506 facilitate interaction with a user or other devices (network communications) in the network. Each input/output device 2506 includes any suitable structure for providing information to or receiving information from a user, such as a speaker, microphone, keypad, keyboard, display, or touch screen, including network interface communications.

In addition, the ED 2510 includes at least one memory 2508. The memory 2508 stores instructions and data used, generated, or collected by the ED 2510. For example, the memory 2508 could store software or firmware instructions executed by the processing unit(s) 2500 and data used to reduce or eliminate interference in incoming signals. Each memory 2508 includes any suitable volatile or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 24B, the base station 2570 includes at least one processing unit 2550, at least one transceiver 2552, which includes functionality for a transmitter and a receiver, one or more antennas 2556, at least one memory 2558, and one or more input/output devices or interfaces 2566. A scheduler, which would be understood by one skilled in the art, is coupled to the processing unit 2550. The scheduler could be included within or operated separately from the base station 2570. The processing unit 2550 implements various processing operations of the base station 2570, such as signal coding, data processing, power control, input/output processing, or any other functionality. The processing unit 2550 can also support the methods and teachings described in more detail above. Each processing unit 2550 includes any suitable processing or computing device configured to perform one or more operations. Each processing unit 2550 could, for example, include a microprocessor, microcontroller, digital signal processor, field programmable gate array, or application specific integrated circuit.

Each transceiver 2552 includes any suitable structure for generating signals for wireless or wired transmission to one or more EDs or other devices. Each transceiver 2552 further includes any suitable structure for processing signals received wirelessly or by wire from one or more EDs or other devices. Although shown combined as a transceiver 2552, a transmitter and a receiver could be separate components. Each antenna 2556 includes any suitable structure for transmitting or receiving wireless or wired signals. While a common antenna 2556 is shown here as being coupled to the transceiver 2552, one or more antennas 2556 could be coupled to the transceiver(s) 2552, allowing separate antennas 2556 to be coupled to the transmitter and the receiver if equipped as separate components. Each memory 2558 includes any suitable volatile or non-volatile storage and retrieval device(s). Each input/output device 2566 facilitates interaction with a user or other devices (network communications) in the network. Each input/output device 2566 includes any suitable structure for providing information to or receiving/providing information from a user, including network interface communications.

FIG. 25 is a block diagram of a computing system 2500 that may be used for implementing the devices and methods disclosed herein. For example, the computing system can be any entity of UE, access network (AN), mobility management (MM), session management (SM), user plane gateway (UPGW), or access stratum (AS). Specific devices may utilize all of the components shown or only a subset of the components, and levels of integration may vary from device to device. Furthermore, a device may contain multiple instances of a component, such as multiple processing units, processors, memories, transmitters, receivers, etc. The computing system 2500 includes a processing unit 2502. The processing unit includes a central processing unit (CPU) 2514, memory 2508, and may further include a mass storage device 2504, a video adapter 2510, and an I/O interface 2512 connected to a bus 2520.

The bus 2520 may be one or more of any type of several bus architectures including a memory bus or memory controller, a peripheral bus, or a video bus. The CPU 2514 may comprise any type of electronic data processor. The memory 2508 may comprise any type of non-transitory system memory such as static random access memory (SRAM), dynamic random access memory (DRAM), synchronous DRAM (SDRAM), read-only memory (ROM), or a combination thereof. In an embodiment, the memory 2508 may include ROM for use at boot-up, and DRAM for program and data storage for use while executing programs.

The mass storage 2504 may comprise any type of non-transitory storage device configured to store data, programs, and other information and to make the data, programs, and other information accessible via the bus 2520. The mass storage 2504 may comprise, for example, one or more of a solid state drive, hard disk drive, a magnetic disk drive, or an optical disk drive.

The video adapter 2510 and the I/O interface 2512 provide interfaces to couple external input and output devices to the processing unit 2502. As illustrated, examples of input and output devices include a display 2518 coupled to the video adapter 2510 and a mouse, keyboard, or printer 2516 coupled to the I/O interface 2512. Other devices may be coupled to the processing unit 2502, and additional or fewer interface cards may be utilized. For example, a serial interface such as Universal Serial Bus (USB) (not shown) may be used to provide an interface for an external device.

The processing unit 2502 also includes one or more network interfaces 2506, which may comprise wired links, such as an Ethernet cable, or wireless links to access nodes or different networks. The network interfaces 2506 allow the processing unit 2502 to communicate with remote units via the networks. For example, the network interfaces 2506 may provide wireless communication via one or more transmitters/transmit antennas and one or more receivers/receive antennas. In an embodiment, the processing unit 2502 is coupled to a local-area network 2522 or a wide-area network for data processing and communications with remote devices, such as other processing units, the Internet, or remote storage facilities.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a performing unit or module, a generating unit or module, an obtaining unit or module, a setting unit or module, an adjusting unit or module, an increasing unit or module, a decreasing unit or module, a determining unit or module, a modifying unit or module, a reducing unit or module, a removing unit or module, or a selecting unit or module. The respective units or modules may be hardware, software, or a combination thereof. For instance, one or more of the units or modules may be an integrated circuit, such as field programmable gate arrays (FPGAs) or application-specific integrated circuits (ASICs).

Although the present disclosure and its advantages have been described in detail, it should be understood that various changes, substitutions and alterations can be made herein without departing from the scope of the disclosure as defined by the appended claims.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

What is claimed is:

1. A method comprising:
receiving, by a reduced capability (RedCap) user equipment (UE), a system information block (SIB), in a first initial downlink (DL) bandwidth part (BWP) based on a first configuration within a master information block (MIB) received by the RedCap UE, the SIB indicating a second configuration for a second initial DL BWP, wherein the RedCap UE has a maximum bandwidth capability less than a minimum bandwidth capability for a non-RedCap UE, and wherein a bandwidth of the second initial DL BWP is smaller than or equal to the maximum bandwidth capability;
receiving, by the RedCap UE, first transmissions in the first initial DL BWP before an initial access procedure; and
receiving, by the RedCap UE, second transmissions in the second initial DL BWP in response to the RedCap UE transmitting a random access channel (RACH).

2. The method of claim 1, wherein the SIB comprises a configuration for an initial uplink (UL) BWP, a bandwidth of the initial UL BWP being smaller than or equal to the maximum bandwidth capability, the method further comprising:
transmitting, by the RedCap UE, the RACH during the initial access procedure, in resources of the initial UL BWP.

3. The method of claim 2, wherein a first center of the initial UL BWP is aligned to a second center of the second initial DL BWP, and wherein the RedCap UE operates with time-division duplexing.

4. The method of claim 1, wherein the SIB comprises a configuration for an initial uplink (UL) BWP, a bandwidth of the initial UL BWP being less than or equal to the maximum bandwidth capability, the method further comprising:
transmitting, by the RedCap UE, uplink control information in a physical uplink control channel (PUCCH) during the initial access procedure in first resources of the initial UL BWP.

5. The method of claim 4, wherein the transmitting of the uplink control information is in second resources located on a side of the initial UL BWP in accordance with a configuration of PUCCH resources.

6. The method of claim 5, wherein the configuration of the PUCCH resources comprises an offset, a size of the PUCCH resources, and an indication of the side of the initial UL BWP.

7. The method of claim 1, wherein the first configuration comprises a first control channel resource set configuration, and wherein the second configuration comprises a second control channel resource set configuration.

8. A method comprising:
transmitting, by a base station, parameters for a first initial downlink (DL) bandwidth part (BWP) in a master information block (MIB), the MIB indicating a first configuration for the first initial DL BWP;
transmitting, by the base station, a system information block (SIB), the SIB indicating a second configuration for a second initial DL BWP for a reduced capability (RedCap) UE, wherein the RedCap UE has a maximum bandwidth capability less than a minimum bandwidth capability for a non-RedCap UE, and wherein a bandwidth of the second initial DL BWP is less than or equal to the maximum bandwidth capability; and
transmitting, by the base station, initial access messages in the second initial DL BWP in response to receiving a random access channel (RACH) from the RedCap UE.

9. The method of claim 8, wherein the SIB further indicates a configuration for an initial uplink (UL) BWP, a bandwidth of the initial UL BWP being less than or equal to the maximum bandwidth capability.

10. The method of claim 9, wherein a first center of the initial UL BWP is aligned to a second center of the second initial DL BWP, and wherein the base station operates with time-division duplexing.

11. The method of claim 8, further comprising:
configuring, by the base station, first parameters for a first RACH transmission for the non-RedCap UE and second parameters for a second RACH transmission for the RedCap UE.

12. The method of claim 9, further comprising:
receiving, by the base station, uplink control information from the RedCap UE in a physical uplink control channel (PUCCH) during an initial access procedure in first resources of the initial UL BWP.

13. The method of claim 12, wherein the receiving of the uplink control information in the PUCCH is in second resources located on a side of the initial UL BWP in accordance with a configuration of PUCCH resources.

14. The method of claim 13, wherein the configuration of the PUCCH resources comprises an offset, a size of the PUCCH resources, and an indication of the side of the initial UL BWP.

15. The method of claim 8, wherein the first configuration comprises a first control channel resource set configuration, and wherein the second configuration comprises a second control channel resource set configuration.

16. A reduced capability (RedCap) user equipment (UE) comprising:
one or more processors; and
a non-transitory memory storage comprising instructions that, when executed by the one or more processors, cause the RedCap UE to perform operations including:
receiving a system information block (SIB), in a first initial downlink (DL) bandwidth part (BWP) based on a first configuration within a master information block (MIB) received by the RedCap UE, the SIB indicating a second configuration for a second initial DL BWP, wherein the RedCap UE has a maximum bandwidth capability less than a minimum bandwidth capability for a non-RedCap UE, and wherein a bandwidth of the second initial DL BWP is smaller than or equal to the maximum bandwidth capability;
receiving first transmissions in the first initial DL BWP before an initial access procedure; and
receiving second transmissions in the second initial DL BWP in response to the RedCap UE transmitting a random access channel (RACH).

17. The RedCap UE of claim 16, wherein the SIB comprises a configuration for an initial uplink (UL) BWP, a bandwidth of the initial UL BWP being smaller than or equal to the maximum bandwidth capability, the operations further comprising:
transmitting, by the RedCap UE, the RACH during the initial access procedure, in resources of the initial UL BWP.

18. The RedCap UE of claim 17, wherein a first center of the initial UL BWP is aligned to a second center of the second initial DL BWP, and wherein the RedCap UE operates with time-division duplexing.

19. A base station comprising:
one or more processors; and
a non-transitory memory storage comprising instructions that, when executed by the one or more processors, cause the base station to perform operations including:
transmitting parameters for a first initial downlink (DL) bandwidth part (BWP) in a master information block (MIB), the MIB indicating a first configuration for the first initial DL BWP;
transmitting a system information block (SIB), the SIB indicating a second configuration for a second initial DL BWP for a reduced capability (RedCap) UE, wherein the RedCap UE has a maximum bandwidth capability less than a minimum bandwidth capability for a non-RedCap UE, and wherein a bandwidth of the second initial DL BWP is less than or equal to the maximum bandwidth capability; and
transmitting initial access messages in the second initial DL BWP in response to receiving a random access channel (RACH) from the RedCap UE.

20. The base station of claim 19, wherein the SIB further indicates a configuration for an initial uplink (UL) BWP, a bandwidth of the initial UL BWP being less than or equal to the maximum bandwidth capability.
